(19) United States
(12) Patent Application Publication
(10) Pub. No.: US 2026/0172707 A1
(43) Pub. Date: Jun. 18, 2026

(54) PHOTOELECTRIC CONVERSION DEVICE AND PHOTOELECTRIC CONVERSION SYSTEM

(71) Applicant: CANON KABUSHIKI KAISHA, Tokyo (JP)

(72) Inventors: KAZUNORI MATSUYAMA, Kanagawa (JP); NORIYUKI SHIKINA, Tokyo (JP)

(21) Appl. No.: 19/415,827

(22) Filed: Dec. 11, 2025

(30) Foreign Application Priority Data
Dec. 16, 2024 (JP) 2024-220225

(51) Int. Cl. H04N 25/60; H04N 25/78

(52) U.S. Cl. CPC H04N 25/60; H04N 25/78

(57) ABSTRACT

A photoelectric conversion device includes a pixel outputting analog reference signal and analog image signal, and a readout unit outputting digital reference signal obtained by gain processing and AD conversion processing on the analog reference signal and digital image signal obtained by AD conversion processing and gain processing with first or second gain on the analog image signal, and a differential processing unit outputting first value generated by differential processing between the digital image signal and the digital reference signal when the gain processing is performed on the analog image signal with the first gain or digital signal value of the digital reference signal is less than a determination value and outputting second value different from a value generated by the differential processing when the gain processing with the second gain is performed on the analog image signal and the digital signal value is not less than the determination value.

### BACKGROUND

### Field of the Technology

The present disclosure relates to a photoelectric conversion device and a photoelectric conversion system.

### Description of the Related Art

In a case where high-luminance light is incident, charge generated in the photoelectric conversion element may overflow to a floating diffusion, and a value of a reference signal corresponding to a dark state may increase. In such a case, since an image signal is in a saturated state and the reference signal is in an increased state, the value of the signal obtained as the difference between the image signal and the reference signal becomes smaller than the value corresponding to an actual luminance. As a result, a phenomenon in which a high-luminance region actually appears to have low luminance, that is, a so-called blackening phenomenon may occur. Japanese Patent Laid-Open No. 2017-028513 describes a method of correcting the blackening by replacing a difference signal with a predetermined correction value when a predetermined condition is satisfied, such as when an image signal and a reference signal exceed a predetermined threshold value.

However, in the technique described in Japanese Patent Laid-Open No. 2017-028513, when a pixel signal is processed using a plurality of different gain settings, it may not be possible to perform appropriate blackening correction.

### SUMMARY

The present disclosure is directed to provide a photoelectric conversion device

capable of performing appropriate blackening correction even when pixel signals are processed using a plurality of different gain settings.

According to one embodiment of the present specification, there are provided a photoelectric conversion device including a pixel including a photoelectric conversion unit configured to generate charge by photoelectric conversion, the pixel being configured to output an analog reference signal and an analog image signal, a readout unit configured to perform gain processing and analog-to-digital conversion processing on the analog reference signal and the analog image signal to output a digital reference signal obtained by the gain processing and the analog-to-digital conversion processing on the analog reference signal and a digital image signal obtained by the analog-to-digital conversion processing and the gain processing with a first gain or a second gain smaller than the first gain on the analog image signal, and a difference processing unit configured to output a first value generated by difference processing between the digital image signal and the digital reference signal in a case where the analog image signal is subjected to the gain processing with the first gain or a digital signal value of the digital reference signal is less than a first determination value and output a second value different from a value generated by the difference processing in a case where the analog image signal is subjected to the gain processing with the second gain and the digital signal value is equal to or greater than the first determination value.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a schematic configuration of a photoelectric conversion device according to a first embodiment.

FIG. 2 is a diagram illustrating a configuration example of a pixel, a readout unit, and a DSP in the photoelectric conversion device according to the first embodiment.

FIG. 3 is a timing chart illustrating a method of driving the photoelectric conversion device according to the first embodiment.

FIG. 4 is a block diagram illustrating a schematic configuration of a photoelectric conversion device according to a second embodiment.

FIG. 5A and FIG. 5B are diagrams illustrating distributions of count values of reference signals in a state where normal light is incident.

FIG. 6 is a block diagram illustrating a schematic configuration of a photoelectric conversion device according to a third embodiment.

FIG. 7 is a timing chart illustrating a method of driving the photoelectric conversion device according to the third embodiment.

FIG. 8 is a block diagram illustrating a schematic configuration of a photoelectric conversion device according to a fourth embodiment.

FIG. 9 is a timing chart illustrating a method of driving the photoelectric conversion device according to the fourth embodiment.

FIG. 10 is a block diagram illustrating a schematic configuration of an imaging system according to a fifth embodiment.

FIG. 11A is a diagram illustrating a configuration example of an imaging system according to a sixth embodiment.

FIG. 11B is a diagram illustrating a configuration example of a movable object according to the sixth embodiment.

FIG. 12 is a block diagram illustrating a schematic configuration of an equipment according to a seventh embodiment.

### DESCRIPTION OF THE EMBODIMENTS

Hereinafter, embodiments will be described in detail with reference to the accompanying drawings. Note that the following embodiments do not limit the technology according to the claims. Although a plurality of features is described in the embodiments, not all of the plurality of features are essential to the present technology, and the plurality of features may be arbitrarily combined.

In each of the embodiments described below, a photoelectric conversion device for imaging purposes will be mainly described as an example of a photoelectric conversion device. However, each of the embodiments is not limited to the photoelectric conversion devices for imaging purposes and may be applied to other photoelectric conversion devices. For example, other examples of the photoelectric conversion device include a ranging device (a device for distance measurement and the like using a focus detection or a time of flight (TOF)), and a photometric device (a device for measuring the amount of incident light).

In the present specification, even when the ratio of the output voltage to the input voltage is 1 or less, this ratio is expressed as “gain.” It is assumed that signal processing with a gain of 1 or less is also included in “amplification.” That is, what is generally called “buffering” (gain is about 1) or “attenuation” (gain is less than 1) is also included in “amplification.”

### First Embodiment

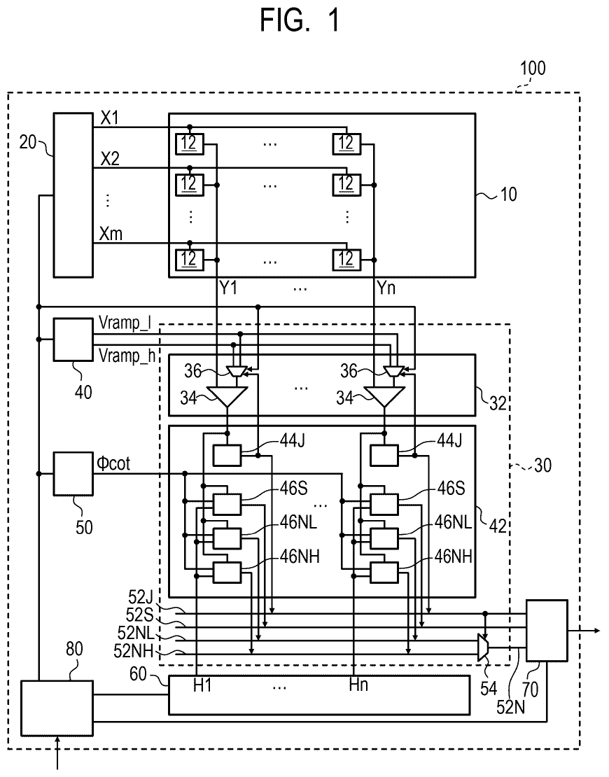

A photoelectric conversion device according to a first embodiment will be described with reference to FIG. 1. FIG. 1 is a block diagram illustrating a schematic configuration of a photoelectric conversion device according to the present embodiment.

As illustrated in FIG. 1, the photoelectric conversion device 100 according to the present embodiment includes a pixel unit 10, a vertical scanning circuit 20, a readout unit 30, a reference signal output circuit 40, and a counter 50. The photoelectric conversion device 100 further includes a horizontal scanning circuit 60, a digital signal processor (DSP) 70, and a timing generation circuit (TG) 80.

The pixel unit 10 is provided with a plurality of pixels 12 arranged in a matrix of m-number of rows×n-number of columns over a plurality of rows (m-number of rows) and a plurality of columns (n-number of columns). Each pixel 12 includes a photoelectric conversion unit including a photoelectric conversion element such as a photodiode, and outputs a pixel signal according to the amount of incident light. The number of rows and the number of columns of the pixel array arranged in the pixel unit 10 are not particularly limited. In addition to an effective pixel that outputs a pixel signal according to the amount of incident light, an optical black pixel in which a photoelectric conversion unit is shielded, a dummy pixel that does not output a signal, or the like may be arranged in the pixel unit 10. A specific configuration of the pixel 12 will be described later.

In each row of the pixel unit 10, row control signal lines X (X1, X2, . . . , and Xm) are arranged so as to extend in a first direction (lateral direction in FIG. 1). Each of the row control signal lines X is connected to each of the pixels 12 arranged in the first direction on the corresponding row and forms a signal line common to these pixels 12. The first direction in which the row control signal lines X extend may be referred to as a row direction or a horizontal direction. The row control signal lines X are connected to the vertical scanning circuit 20. Each of the row control signal lines X may include a plurality of signal lines.

In each column of the pixel unit 10, signal output lines Y (Y1, . . . , and Yn) are arranged so as to extend in a second direction (vertical direction in FIG. 1) intersecting the first direction. Each of the signal output lines Y is connected to each of the pixels 12 arranged in the second direction on the corresponding column and forms a signal line common to these pixels 12. The second direction in which the signal output lines Y extend may be referred to as a column direction or a vertical direction. The signal output lines Y are connected to the readout unit 30.

The vertical scanning circuit 20 is a control circuit having a function of generating a control signal for driving the pixels 12 and supplying the generated control signal to the pixel unit 10. A logic circuit such as a shift register or an address decoder may be used as the vertical scanning circuit 20. The vertical scanning circuit 20 sequentially outputs the control signal to the row control signal line X of each row and sequentially drives (vertically scans) the pixels 12 of the pixel unit 10 row by row. As a result, the pixels 12 in each row of the pixel unit 10 are sequentially selected, and the pixel signal Vpix which is an analog signal is output from each pixel 12. The pixel signal Vpix includes two types of signals, i.e., a reference signal Vn (analog reference signal) and an image signal Vs (analog image signal). The reference signal Vn is a signal indicating a reference level at the time of resetting the pixel 12, and the image signal Vs is a signal obtained by superimposing the reference signal Vn on a signal corresponding to the amount of light incident on the pixel 12. Although the term “image signal” is used in this specification assuming a photoelectric conversion device for obtaining an image, the image signal Vs is not necessarily a signal used for forming an image. The pixel signals Vpix output from the pixels 12 in each column are transmitted to the readout unit 30 via the signal output line Y.

The readout unit 30 includes a plurality of column circuit units corresponding to each column of the pixel unit 10. Each of the column circuit units is a processing circuit that performs predetermined processing on the pixel signals read out from the pixels 12 in the corresponding column. Examples of the processing performed by the column circuit units include signal processing such as amplification processing and analog-to-digital (AD) conversion processing. In the present embodiment, it is assumed that the column circuit unit of each column includes an AD conversion circuit that performs AD conversion processing on the pixel signal Vpix output from the pixel unit 10. The processing in the column circuit unit of each column is performed in parallel.

Each of the column circuit units includes a comparison circuit 34, a reference signal selection unit 36, a memory 44J, a memory 46S, a memory 46NL, and a memory 46NH. In the present embodiment, a functional block including the comparison circuit 34 and the reference signal selection unit 36 in each column may be referred to as a comparison unit 32, and a functional block including the memories 44J, 46S, 46NL, and 46NH in each column may be referred to as a memory unit 42. The readout unit 30 further includes a reference signal selection unit 54.

One input node of the comparison circuit 34 is connected to the signal output line Y of the corresponding column. The other input node of the comparison circuit 34 is connected to an output node of the reference signal selection unit 36. An output node of the comparison circuit 34 is connected to an input node of the memory 44J and first input nodes of the memories 46S, 46NL, and 46NH. Second input nodes of the memories 46S, 46NL, and 46NH are connected to the counter 50. Third input nodes of the memories 46S, 46NL, and 46NH are connected to the horizontal scanning circuit 60. Output nodes of the memories 44J, 46S, 46NL, and 46NH are connected to horizontal transfer lines 52J, 52S, 52NL, and 52NH, respectively. The output node of the memory 44J is also connected to a control node of the reference signal selection unit 36. The horizontal transfer lines 52NL and 52NH are connected to input nodes of the reference signal selection unit 54. An output node of the reference signal selection unit 54 is connected to the horizontal transfer line 52N. The horizontal transfer lines 52J, 52S, and 52N are connected to the DSP 70. The horizontal transfer line 52J is also connected to a control node of the reference signal selection unit 54.

The reference signal output circuit 40 has a function of outputting the reference signals Vramp_l and Vramp_h used for AD conversion. The reference signals Vramp_l and Vramp_h output from the reference signal output circuit 40 are supplied to the other input node of the comparison circuit 34 of each column via the reference signal selection unit 36. At this time, the reference signal selection unit 36 selects one of the reference signals Vramp_l and Vramp_h in accordance with a control signal from the TG 80 described later and a luminance identification signal from the memory 44J, and outputs the selected reference signal to the other input node of the comparison circuit 34. The reference signal output circuit 40 further has a function of outputting a determination voltage for luminance determination. The reference signal output circuit 40 may have a function of generating a reference signal or may be configured to buffer and output a reference signal generated outside the photoelectric conversion device.

The counter 50 has a function of counting a clock pulse signal supplied from the TG 80 and supplying a counter signal Φcot indicating a count value to the memories 46S, 46NL, and 46NH of each column. The counter 50 starts a counting operation in synchronization with a timing at which changes in the signal levels of the reference signals Vramp_l and Vramp_h output from the reference signal output circuit 40 start. The column circuit unit of each column may have the function of the counter 50.

The horizontal scanning circuit 60 is a control circuit having a function of generating control signals H (H1, . . . , and Hn) for reading out digital data held by the memories 46S, 46NL, and 46NH of each column and supplying the generated control signals to the memory unit 42. A logic circuit such as a shift register or an address decoder may be used as the horizontal scanning circuit 60. The horizontal scanning circuit 60 sequentially outputs the control signal H to the memories 46S, 46NL, and 46NH of each column to thereby sequentially output digital data held by the memories 46S, 46NL, and 46NH of each column to the horizontal transfer lines 52S, 52NL, and 52NH. The signal held in the memory 44J is input to the DSP 70 and the reference signal selection unit 54 via the horizontal transfer line 52J. The reference signal selection unit 54 selects one of the signals output from the memories 46NL and 46NH in accordance with the signal from the memory 44J and outputs the selected signal to the horizontal transfer line 52N. The signals of the horizontal transfer lines 52S and 52N are input to the DSP 70.

The DSP 70 is a signal processing circuit that performs predetermined signal processing based on the digital data input via the horizontal transfer lines 52S and 52N and the luminance identification signal input via the horizontal transfer line 52J, and outputs the processed image data to the outside. Examples of the processing performed in the DSP 70 include signal processing such as saturation detection and noise reduction of the pixels 12. An external interface circuit included in the DSP 70 is not particularly limited. As the external interface circuit, for example, a serializer/deserializer (SerDes) transmission circuit may be applied. The SerDes transmission circuit is, for example, a low voltage differential signaling (LVDS) circuit or a scalable low voltage signaling (SLVS) circuit.

The TG 80 has a function of outputting control signals to the vertical scanning circuit 20, the reference signal output circuit 40, the counter 50, the horizontal scanning circuit 60, the DSP 70, and the like based on a predetermined processing flow to control them. The TG 80 performs these operations based on external control. For example, the TG 80 may be controlled by a system control unit of an imaging system in which the photoelectric conversion device 100 is mounted. At least a part of the control signals supplied to the vertical scanning circuit 20, the reference signal output circuit 40, the counter 50, the horizontal scanning circuit 60, and the DSP 70 may be supplied from the outside of the photoelectric conversion device 100.

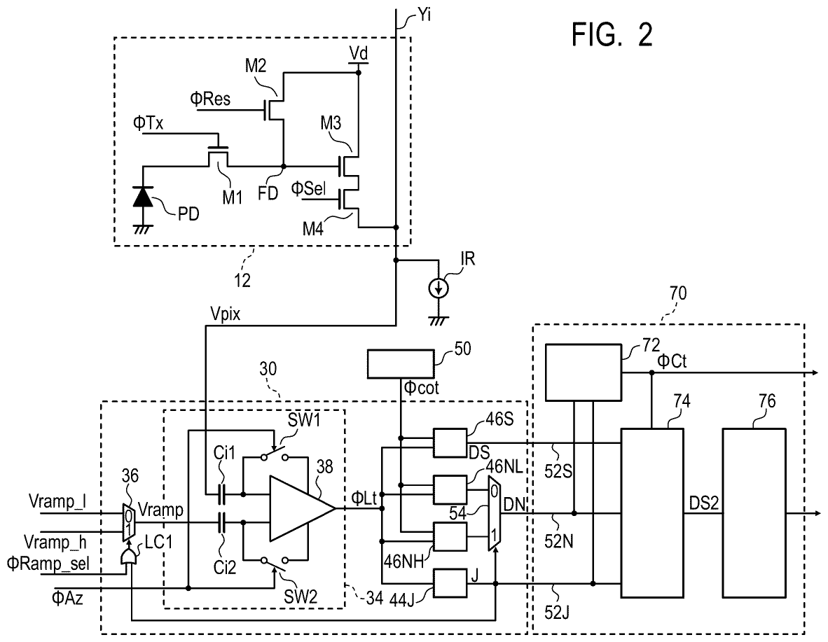

Next, a more detailed configuration example and operation of the pixel 12, the readout unit 30, and the DSP 70 will be described with reference to FIG. 2. FIG. 2 is a diagram illustrating a configuration example of the pixel 12, the readout unit 30, and the DSP 70 in the photoelectric conversion device according to the present embodiment. For simplification of the drawing, one pixel 12 arranged in the i-th column and a column circuit unit arranged in the i-th column are extracted and illustrated in FIG. 2 (i is an integer of 1 or more and n or less).

As illustrated in, e.g., FIG. 2, the pixel 12 may include a photoelectric conversion element PD, a transfer transistor M1, a reset transistor M2, an amplifier transistor M3, and a select transistor M4.

The photoelectric conversion element PD may be, for example, a photodiode. The photoelectric conversion element PD has an anode connected to a ground voltage node and a cathode connected to a source of the transfer transistor M1. A drain of the transfer transistor M1 is connected to a source of the reset transistor M2 and a gate of the amplifier transistor M3. A node FD to which the drain of the transfer transistor M1, the source of the reset transistor M2, and the gate of the amplifier transistor M3 are connected is a so-called floating diffusion. The floating diffusion includes a capacitance component (floating diffusion capacitance) and has a function as a charge holding portion. The floating diffusion capacitance may include a gate capacitance, a p-n junction capacitance, an interconnection capacitance, and the like of the transistor. A drain of the reset transistor M2 and a drain of the amplifier transistor M3 are connected to a node to which a power supply voltage (voltage Vd) is supplied. A source of the amplifier transistor M3 is connected to a drain of the select transistor M4. A source of the select transistor M4 is connected to the signal output line Yi.

In the case of the pixel configuration of FIG. 2, the row control signal line X of each row includes three signal lines including a signal line connected to a gate of the transfer transistor M1, a signal line connected to a gate of the reset transistor M2, and a signal line connected to a gate of the select transistor M4. The control signal ΦTx is supplied from the vertical scanning circuit 20 to the gate of the transfer transistor M1. The control signal ΦRes is supplied from the vertical scanning circuit 20 to the gate of the reset transistor M2. The control signal ΦSel is supplied from the vertical scanning circuit 20 to the gate of the select transistor M4. When each transistor is formed of an n-channel MOS transistor, the corresponding transistor is turned on when a high-level control signal is supplied from the vertical scanning circuit 20. When a low-level control signal is supplied from the vertical scanning circuit 20, the corresponding transistor is turned off.

The present embodiment will be described on the assumption that electrons among electron-hole pairs generated in the photoelectric conversion element PD by light incidence are used as signal charge. When electrons are used as the signal charge, each transistor constituting the pixel 12 may be formed of an n-channel MOS transistor. However, the signal charge is not limited to electrons, and holes may be used as the signal charge. When holes are used as the signal charge, the conductivity type of each transistor may be opposite to that described in the present embodiment. The names of the source and the drain of the MOS transistor may vary depending on the conductivity type of the transistor and the function of the transistor focused on. Some or all of the names of the source and the drain used in the present embodiment may be referred to as reverse names.

The photoelectric conversion element PD converts (photoelectrically converts) the incident light into charge of an amount corresponding to the amount of the incident light and accumulates the generated charge. The transfer transistor M1 transfers the charge held by the photoelectric conversion element PD to the node FD by turning on. The charge transferred from the photoelectric conversion element PD is held in the capacitance component (floating diffusion capacitance) of the node FD. As a result, the node FD has a potential corresponding to the amount of charge transferred from the photoelectric conversion element PD by charge-voltage conversion by the floating diffusion capacitance.

The reset transistor M2 has a function of controlling a reset operation for resetting the node FD as a charge holding portion. That is, the reset transistor M2 is a reset unit that resets the node FD to a voltage corresponding to the voltage Vd by turning on.

The select transistor M4 connects the amplifier transistor M3 to the signal output line 16 by turning on. The amplifier transistor M3 has the drain to which the voltage Vd is supplied and the source to which the bias current is supplied from a current source IR via the select transistor M4 and constitutes an amplifier unit (source follower circuit) having the gate as an input node. Accordingly, the amplifier transistor M3 outputs a signal (pixel signal Vpix) based on the potential of the node FD to the signal output line Yi via the select transistor M4. In this sense, the amplifier transistor M3 and the select transistor M4 constitute an output unit that outputs the pixel signal Vpix according to the amount of charge held in the node FD.

As described above, the pixel signal Vpix includes two types of signals, i.e., the reference signal Vn and the image signal Vs. The reference signal Vn is a signal output to the signal output line Yi when the node FD is reset by turning on the reset transistor M2. The image signal Vs is a signal output to the signal output line Yi when the photoelectric charge accumulated in the photoelectric conversion element PD is transferred to the node FD by turning on the transfer transistor M1. That is, the image signal Vs is a signal obtained by superimposing the reference signal Vn on a signal corresponding to the amount of incident light.

The pixel signal Vpix from the pixel 12, the reference signals Vramp_l and Vramp_h from the reference signal output circuit 40, and the control signals ΦRamp_sel and ΦAz from the TG 80 are input to the readout unit 30.

As described above, the reference signals Vramp_l and Vramp_h are signals used for AD conversion. The reference signals Vramp_l and Vramp_h may have a predetermined amplitude according to the range of the pixel signal Vpix and may be signals whose signal levels change with time. Although the reference signal is not particularly limited, for example, a ramp signal in which the signal level monotonically increases or monotonically decreases with time may be applied. Note that the change in the signal level does not necessarily have to be continuous and may be stepwise. In addition, the change in the signal level does not necessarily need to be linear with respect to time and may be curved with respect to time (for example, a sine wave or a cosine wave). In the present embodiment, it is assumed that the reference signal output circuit 40 outputs two types of ramp signals (reference signals Vramp_l and Vramp_h) having different rates of change in the signal level over time.

Here, the reference signal Vramp_l is a reference signal used in AD conversion of the low luminance signal, and the reference signal Vramp_h is a reference signal used in AD conversion of the high luminance signal. The amplitude of the reference signal Vramp_h is larger than that of the reference signal Vramp_l by the reciprocal of the gain ratio, and the slope of the reference signal Vramp_h is steeper than that of the reference signal Vramp_l. Here, the gain ratio is a ratio (G1/G2) of the gain G1 when the reference signal Vramp_l is used to the gain G2 when the reference signal Vramp_h is used. The reference signals Vramp_l and Vramp_h may be generated, for example, by outputting a current generated using a current digital-to-analog converter (IDAC) through a load element. In this case, the slopes of the reference signals Vramp_l and Vramp_h may be controlled by the driving frequency of the IDAC. It can be said that the dual slope AD conversion circuit has a gain processing function and an AD conversion processing function.

The reference signal selection unit 36 selects one of the reference signals Vramp_l and Vramph supplied from the reference signal output circuit 40 and outputs the selected reference signal to the comparison circuit 34. The control signal ΦRamp_sel and the luminance identification signal J are input to the control node of the reference signal selection unit 36 via the OR circuit LC1. Accordingly, when at least one of the control signal ΦRamp_sel and the luminance identification signal J is at high-level, the reference signal selection unit 36 selects the reference signal Vramp_h as the reference signal Vramp. When the control signal ΦRamp_sel and the luminance identification signal J are at low-level, the reference signal selection unit 36 selects the reference signal Vramp_l as the reference signal Vramp. In the following description, the reference signal selected by the reference signal selection unit 36 among the reference signals Vramp_l and Vramp_h may be referred to as a reference signal Vramp.

The reference signal output circuit 40 further has a function of outputting a determination voltage Vjudge indicating a voltage level for switching between the AD conversion processing on the low luminance side and the AD conversion processing on the high luminance side. The determination voltage Vjudge may be set to a voltage equal to or less than the maximum amplitude of the reference signal Vramp_l. The determination voltage Vjudge may be supplied to the comparison circuit 34 through a path similar to that of the reference signal Vramp_l. The reference signal output circuit 40 outputs one of the reference signal Vramp_l and the determination voltage Vjudge in response to a control signal (a control signal ΦJudge described later) supplied from the TG 80. For example, the reference signal output circuit 40 outputs the reference signal Vramp_l when the control signal ΦJudge is at low-level, and outputs the determination voltage Vjudge when the control signal ΦJudge is at high-level.

As illustrated in, e.g., FIG. 2, the comparison circuit 34 may include a comparator 38, clamp capacitors Ci1 and Ci2, and reset switches SW1 and SW2. The comparator 38 may include a differential amplifier circuit. The comparator 38 has two input nodes and one output node. One input node of the comparator 38 is connected to the signal output line Yi via the clamp capacitor Ci1. The other input node of the comparator 38 is connected to the output node of the reference signal selection unit 36 via the clamp capacitor Ci2. The reset switches SW1 and SW2 are connected to the comparator 38. The output node of the comparator 38 is connected to the memories 44J, 46S, 46NL, and 46NH.

The reset switches SW1 and SW2 are controlled by a control signal ΦAZ from the TG 80 and are turned on (conductive state) when the control signal ΦAZ is at high-level and are turned off (nonconductive state) when the control signal ΦAZ is at low-level, for example. When the reset switches SW1 and SW2 are turned on, the voltages clamped in the clamp capacitors Ci1 and Ci2 are reset.

The comparator 38 compares the level of the pixel signal Vpix input via the clamp capacitor Ci1 with the level of the reference signal Vramp input via the clamp capacitor Ci2 and outputs a signal according to the comparison result. For example, the comparator 38 outputs a high-level signal when the level of the reference signal Vramp is higher than the level of the pixel signal Vpix and outputs a low-level signal when the level of the pixel signal Vpix is higher than the level of the reference signal Vramp. Then, the comparator 38 outputs a pulse signal which becomes high-level when the magnitude relationship between the level of the reference signal Vramp and the level of the pixel signal Vpix is inverted. This pulse signal is a latch signal ΦLt. The latch signal ΦLt is output to the memories 46S, 46NL, and 46NH. The magnitude relation of the input signal when the latch signal ΦLt is output may be reversed. The comparison processing in the comparison circuit 34 of each column is performed in parallel.

The counter 50 starts a counting operation of the clock pulse signal supplied from the TG 80 in synchronization with a timing at which a change in the signal level of the reference signal Vramp starts and outputs a counter signal Φcot indicating a count value to the memories 46S, 46NL, and 46NH. The memories 46S, 46NL, and 46NH temporarily hold the count value indicated by the counter signal Φcot at the timing of receiving the latch signal ΦLt as digital data of the pixel signal Vpix. In this manner, AD conversion of the pixel signal Vpix is performed for each column. The reference signal Vn (digital reference signal) after the AD conversion is held in the memories 46NL and 46NH, and the image signal Vs (digital image signal) after the AD conversion is held in the memory 46S. The digital data held in the memories 46S, 46NL, and 46NH may be, for example, 12-bit binary digital data.

The comparator 38 compares the level of the pixel signal Vpix input via the clamp capacitor Ci1 with the level of the determination voltage Vjudge input via the clamp capacitor Ci2, and outputs a signal corresponding to the comparison result. As a result of the comparison, when the amplitude of the pixel signal Vpix is larger than the amplitude corresponding to the determination voltage Vjudge, the memory 44J holds the digital value 1 as the luminance identification signal J. As a result of the comparison, when the amplitude of the pixel signal Vpix is equal to or less than the amplitude corresponding to the determination voltage Vjudge, the memory 44J holds the digital value 0 as the luminance identification signal J. The luminance identification signal J held in the memory 44J is output to the reference signal selection unit 54 and the OR circuit LC1.

The memory 46S outputs the held digital signal to the horizontal transfer line 52S in response to the control signal Hi from the horizontal scanning circuit. This digital signal is a digital signal DS (digital image signal) corresponding to the image signal Vs. Similarly, the memories 46NL and 46NH output the held digital signals to the horizontal transfer lines 52NL and 52NH, respectively, in response to the control signal Hi from the horizontal scanning circuit. In addition, the memory 44J outputs the held luminance identification signal J to the reference signal selection unit 54 via the horizontal transfer line 52J. The reference signal selection unit 54 selects one of the digital signal output to the horizontal transfer line 52NL and the digital signal output to the horizontal transfer line 52NH according to the luminance identification signal J and outputs the selected digital signal to the horizontal transfer line 52N. That is, the reference signal selection unit 54 selects the digital signal output from the memory 46NH when the luminance identification signal J is 1 and selects the digital signal output from the memory 46NL when the luminance identification signal J is 0. The digital signal output to the horizontal transfer line 52N is a digital signal DN (digital reference signal) corresponding to the reference signal Vn. The digital signals DS and DN output to the horizontal transfer lines 52S and 52N and the luminance identification signal J output to the horizontal transfer line 52J are input to the DSP 70.

As illustrated in, e.g., FIG. 2, the DSP 70 includes a determination unit 72, a difference processing unit 74, and a signal processing unit 76. The determination unit 72 is connected to the horizontal transfer lines 52N and 52J. The difference processing unit 74 is connected to the horizontal transfer lines 52S, 52N, and 52J and the determination unit 72. The signal processing unit 76 is connected to the difference processing unit 74.

The determination unit 72 has a function of determining whether or not the signal level of the digital signal DN is in a high luminance blackening state. The high-luminance blackening state occurs in a case where the reference voltage is decreased by leaking the charge of the saturated photoelectric conversion element PD to the node FD to increase the value of the digital signal DN. Since the high-luminance blackening state occurs when excessive light is incident, the luminance identification signal J when the high-luminance blackening state occurs is 1. Therefore, when the luminance identification signal J is 1 and the digital signal DN is larger than the digital signal value of the reference voltage generated when the incident light amount is in the normal range, the determination unit 72 determines that the state is the high luminance blackening state.

The determination unit 72 includes a storage unit such as a register and holds a predetermined determination value used for the determination. The predetermined determination value is a threshold value to be compared with the digital reference signal. The determination value is determined based on a value corresponding to an output value of the reference voltage when the photoelectric conversion element PD is saturated in a case where AD conversion using the reference signal Vramp_h is performed. For example, as the determination value, a value that is slightly larger than the value corresponding to the output value of the reference voltage when the photoelectric conversion element PD is saturated, taking into account variations, in the case where the AD conversion using the reference signal Vramp_h is performed may be set. In the present embodiment, this determination value is referred to as determination data DN_H (digital reference signal determination value).

The determination unit 72 compares the digital signal DN with the determination data DN_H. As a result of the comparison, when the digital signal value of the digital signal DN is equal to or greater than the determination value of the determination data DN_H, the determination unit 72 outputs a high-level determination signal ΦCT as a signal indicating the determination result. On the other hand, when the digital signal value of the digital signal DN is less than the determination value of the determination data DN_H, the determination unit 72 outputs a low-level determination signal ΦCT as a signal indicating the determination result.

The difference processing unit 74 includes a difference circuit that calculates a difference between the digital signal DS and the digital signal DN, and a correction circuit that corrects a gain difference between the low luminance signal and the high luminance signal. The difference circuit performs a difference process of subtracting the digital signal DN from the digital signal DS to remove the influence of the voltage of the reference signal of the pixel 12, the offset voltage of the comparison circuit 34, and the like, and outputs the digital signal DS2 corresponding to the photoelectric converted charge. The correction circuit is a circuit that performs correction processing for substantially equalizing gains in the case of AD conversion using the reference signal Vramp_l and the case of AD conversion using the reference signal Vramp_h. Since a difference corresponding to the gain ratio occurs between the output values of the reference signal Vramp at the time of low luminance and the output values of the reference signal Vramp at the time of high luminance, the result of the AD conversion when the AD conversion is performed using the reference signal Vramp_h is converted into a value equivalent to that when the AD conversion is performed using the reference signal Vramp_l by multiplying the result of the AD conversion by the gain ratio.

The difference processing unit 74 outputs one of the following two types of signals as the digital signal DS2 based on the level of the determination signal ΦCT output from the determination unit 72. That is, when the determination signal ΦCT is at low-level, the difference processing unit 74 outputs a difference value obtained by subtracting the digital signal DN from the digital signal DS as the digital signal DS2. Thus, the influence of the voltage of the reference signal Vn of the pixel 12, the offset voltage of the comparison circuit 34, and the like is removed, and the digital signal DS2 corresponding to the photoelectric converted charge may be obtained. On the other hand, when the determination signal ΦCT is at high-level, the difference processing unit 74 outputs a digital signal having a correction value corresponding to a white level, which is different from a difference value obtained by subtracting the digital signal DN from the digital signal DS, as the digital signal DS2. The digital signal corresponding to the white level may be, for example, a maximum value among values that the digital signal can take.

In other words, in a case where the luminance identification signal J is 0 or the value of the digital signal DN is less than the determination value of the determination data DN_H, the difference processing unit 74 outputs a first value that is a difference value obtained by subtracting the digital signal DN from the digital signal DS. In a case where the luminance identification signal J is 1 and the value of the digital signal DN is equal to or greater than the determination value of the determination data DN_H, the difference processing unit 74 outputs a second value corresponding to the white level.

In a case where the photoelectric conversion element PD is saturated, a false signal generated by the charge overflowing from the photoelectric conversion element PD is superimposed on the digital signal DN. In such a case, the digital signal DS2 may have a signal level lower than the white level by differential processing between the digital signal DS and the digital signal DN. As a result, in the captured image, a blackening phenomenon may occur in which the luminance of a portion to be originally white is lowered. Therefore, in the present embodiment, when it is detected that the photoelectric conversion element PD is saturated, the output signal is replaced with a signal having a signal level corresponding to the white level. This makes it possible to suppress the influence of the blackening phenomenon.

The signal processing unit 76 acquires a digital signal DS3 by performing addition of a black offset signal as a countermeasure against shading of a dark signal, data level shift as digital gain processing of an effective signal, adjustment of the number of data bits, and the like on the digital signal DS2, and outputs the digital signal DS3 to the outside.

In the present embodiment, the determination unit 72 and the difference processing unit 74 are circuits provided in common for each column of the readout unit 30 and sequentially process signals output from the column circuit units of each column. Therefore, in the present embodiment, the circuit scale may be reduced as compared with the case where the determination unit 72 and the difference processing unit 74 are provided for each column. Therefore, according to the present embodiment, it is possible to suppress an increase in the circuit scale while reducing the influence of the blackening phenomenon. Further, according to the present embodiment, the power consumption may be reduced by reducing the circuit scale.

Although the determination signal ΦCT indicating the determination result is supplied from the determination unit 72 to the difference processing unit 74 as described above, the determination signal ΦCT may be output to the outside of the photoelectric conversion device 100 as a flag signal. For example, when the determination signal ΦCT is at high-level, a signal processing unit outside the photoelectric conversion device 100 does not use the corresponding data for correction processing between image data, thereby making it possible to optimize the correction signal level.

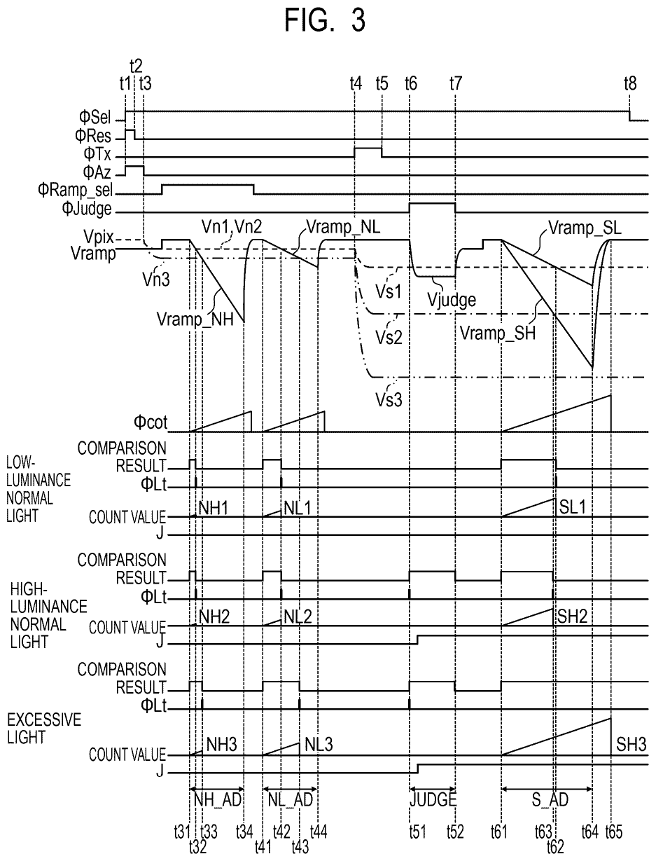

Next, a method of driving the photoelectric conversion device according to the present embodiment will be described with reference to FIG. 3. FIG. 3 is a timing chart illustrating a method of driving the photoelectric conversion device according to the present embodiment. In the present embodiment, a method of processing AD conversion on the reference signal using the reference signal Vramp_l and the reference signal Vramp_h will be described. In FIG. 3, the horizontal direction indicates time, and the vertical direction indicates a schematic waveform of each signal.

The waveforms of the pixel signal Vpix and the reference signal Vramp in FIG. 3 indicate changes in the potentials of signals input from the two input nodes of the comparator 38 and compared in the comparator 38. Further, FIG. 3 illustrates signals of the respective parts in the case where the incident light to the photoelectric conversion element PD is the low-luminance normal light, the high-luminance normal light, and the excessive light. Here, the low-luminance normal light is incident light in a range in which the photoelectric conversion element PD is not saturated, and in this case, the pixel signal Vpix is lower than the determination voltage Vjudge, and AD conversion of the pixel signal Vpix is performed using the reference signal Vramp_l. The high-luminance normal light is incident light in a range in which the photoelectric conversion element PD is not saturated, and in this case, the pixel signal Vpix is higher than the determination voltage Vjudge, and AD conversion of the pixel signal Vpix is performed using the reference signal Vramp_h. The excessive light is incident light having an amount by which the photoelectric conversion element PD is saturated.

In FIG. 3, Vn1 indicates a reference signal in the case of low-luminance normal light, Vn2 indicates a reference signal in the case of high-luminance normal light, and Vn3 indicates a reference signal in the case of excessive light. Further, Vs1 indicates an image signal in the case of low-luminance normal light, Vs2 indicates an image signal in the case of high-luminance normal light, and Vs3 indicates an image signal in the case of excessive light.

In FIG. 3, a period from time t31 to time t34 is an AD conversion period (NH_AD period) of the reference signal Vn using the reference signal Vramp_h. A period from time t41 to time t44 is an AD conversion period (NL_AD period) of the reference signal Vn using the reference signal Vramp_l. A period from time t51 to time t52 is a determination period (JUDGE period) of the pixel signal Vpix using the determination voltage Vjudge. A period from time t61 to time t64 is an AD conversion period (S_AD period) of the image signal Vs.

In the NH_AD period, the comparison circuit 34 compares the reference signal Vn (Vn1 to Vn3) with the reference signal Vramp_h. The reference signal selection unit 36 selects the reference signal Vramp_h as the reference signal Vramp in accordance with the high-level control signal ΦRamp_sel from the TG 80. In the NL_AD period, the comparison circuit 34 compares the reference signal Vn (Vn1 to Vn3) with the reference signal Vramp_l. The reference signal selection unit 36 selects the reference signal Vramp_l as the reference signal Vramp in accordance with the low-level control signal ΦRamp_sel from the TG 80. In each AD period, the counter 50 starts the count operation in synchronization with the start of the change in the signal level of the reference signal Vramp and supplies the counter signal Φcot indicating the count value to the memories 46NL and 46NH. When the magnitude relationship between the potential of the pixel signal Vpix and the potential of the reference signal Vramp is inverted, the comparison circuit 34 outputs the latch signal ΦLt based on the comparison result. The memories 46NL and 46NH hold the count value indicated by the counter signal Φcot as digital data of the reference signal Vn at the timing of receiving the latch signal ΦLt.

In the JUDGE period, the comparison circuit 34 compares the image signal Vs (Vs1 to Vs3) with the determination voltage Vjudge. When the magnitude relationship between the potential of the pixel signal Vpix and the potential of the determination voltage Vjudge is inverted, the comparison circuit 34 outputs the latch signal ΦLt based on the comparison result. The memory 44J holds a digital value 0 in advance as the luminance identification signal J and holds a digital value 1 as the luminance identification signal J when the latch signal ΦLt is received. The reference signal selection unit 36 selects the reference signal Vramp used in the S_AD period from the reference signals Vramp_l and Vramp_h based on the luminance identification signal J set in the JUDGE period.

In the S_AD period, the comparison circuit 34 compares the image signal Vs (Vs1 to Vs3) with the reference signal Vramp selected based on the luminance identification signal J. The counter 50 starts the count operation in synchronization with the start of the change in the signal level of the reference signal Vramp and supplies a counter signal Φcot indicating the count value to the memory 46S. When the magnitude relationship between the potential of the pixel signal Vpix and the potential of the reference signal Vramp is inverted, the comparison circuit 34 outputs the latch signal ΦLt based on the comparison result. The memory 46S holds the count value indicated by the counter signal Φcot as digital data of the image signal Vs at the timing when the latch signal ΦLt is received.

First, AD conversion processing and signal processing in the DSP 70 when incident light is low-luminance normal light will be described.

At time t1, the vertical scanning circuit 20 controls the control signal ΦSel of the row to be read out from low-level to high-level. As a result, the select transistor M4 of each of the pixels 12 in the row to be read out is turned on, and the source follower circuit of each of the pixels 12 enters the operation state. That is, the pixels 12 in the row to be read out are selected.

At the time t1, the vertical scanning circuit 20 also controls the control signal ΦRes of the row to be read out from low-level to high-level. As a result, the reset transistor M2 of each of the pixels 12 in the row to be readout is turned on, and the node FD is reset to a potential corresponding to the voltage Vd. The pixel signal Vpix corresponding to the reset potential of the node FD is output to the signal output line Yi.

At the time t1, the TG 80 controls the control signal ΦAz from low-level to high-level. As a result, the reset switches SW1 and SW2 of the comparison circuits 34 are turned on, and the comparison circuits 34 are reset to the initial state.

At the subsequent time t2, the vertical scanning circuit 20 controls the control signal ΦRes of the row to be read out from high-level to low-level. As a result, the reset transistor M2 of each of the pixels 12 in the row to be read out is turned off, and the reset state of the node FD is canceled. A signal obtained when the reset transistor M2 is turned off and the potential of the signal output line Yi is settled is referred to as a reference signal Vn1.

At the subsequent time t3, the TG 80 controls the control signal ΦAz from high-level to low-level. Accordingly, the reset state of the comparison circuit 34 is canceled, the potential of the input side terminal of the clamp capacitor Ci1 becomes the level of the reference signal Vn1, and the potential of the output side terminal of the clamp capacitor Ci1, that is, the potential of one input node of the comparator 38 is clamped to the potential of the reference signal Vn1. Further, the potential of the input side terminal of the clamp capacitor Ci2 becomes the level of the reference potential of the reference signal Vramp_h, and the potential of the output side terminal of the clamp capacitor Ci2, that is, the potential of the other input node of the comparator 38 is clamped to the same potential as the reference signal Vn1.

At the subsequent time t31, the above-described NH_AD period is started. The TG 80 controls the control signal ΦRamp_sel to high-level. As a result, the reference signal Vramp_h is selected as the reference signal Vramp. The reference signal output circuit 40 starts changing the potential of the reference signal Vramp_h. Hereinafter, the reference signal Vramp_h used in the comparison process in the NH_AD period is referred to as a reference signal Vramp_NH. The counter 50 starts the count operation in synchronization with the start of the change in the potential of the reference signal Vramp_NH.

It is assumed that the potential of the reference signal Vramp_NH becomes lower than the potential of the reference signal Vn1 at the subsequent time t32. As a result, a pulse of the latch signal ΦLt is generated, and the count value NH1 indicated by the counter signal Φcot at the time t32 is held in the memory 46NH.

At the subsequent time t41, the above-described NL_AD period is started, and the reference signal output circuit 40 starts changing the potential of the reference signal Vramp_l. Hereinafter, the reference signal Vramp_h used in the comparison process in the NL_AD period is referred to as a reference signal Vramp_NL. The counter 50 starts the count operation in synchronization with the start of the change in the potential of the reference signal Vramp_NL.

It is assumed that the potential of the reference signal Vramp_NL becomes lower than the potential of the reference signal Vn1 at the subsequent time t42. As a result, a pulse of the latch signal ΦLt is generated, and the count value NL1 indicated by the counter signal Φcot at the time t42 is held in the memory 46NL.

At the subsequent time t4, the vertical scanning circuit 20 controls the control signal ΦTx of the row to be read out from low-level to high-level. As a result, the transfer transistor M1 of each of the pixels 12 in the row to be read out is turned on, and the charge accumulated in the photoelectric conversion element PD is transferred to the node FD. The pixel signal Vpix corresponding to the amount of charge transferred to the node FD is output to the signal output line Yi.

At the subsequent time t5, the vertical scanning circuit 20 controls the control signal ΦTx of the row to be read out from high-level to low-level. As a result, the transfer transistor M1 of each of the pixels 12 in the row to be read out is turned off. A signal obtained when the transfer transistor M1 is turned off and the potential of the signal output line Yi is settled is referred to as an image signal Vs1.

At the subsequent time t6, the above-described JUDGE period is started, and the TG 80 controls the control signal ΦJudge supplied to the reference signal output circuit 40 from low-level to high-level in the period from the time t6 to time t7. The reference signal output circuit 40 sets the reference signal Vramp_l to the determination voltage Vjudge in response to the high-level control signal ΦJudge. The reference signal selection unit 36 selects the reference signal Vramp_l (determination voltage Vjudge) as the reference signal Vramp in accordance with the low-level control signal ΦRamp_sel.

The comparison circuit 34 compares the level of the image signal Vs1 with the level of the determination voltage Vjudge. In the low-luminance normal light, since the potential of the image signal Vs1 is higher than the potential of the determination voltage Vjudge, the output of the comparison circuit 34 is not inverted, and the pulse of the latch signal ΦLt is not generated. As a result, the digital value 0 is held as the luminance identification signal J in the memory 44J.

At the subsequent time t61, the above-described S_AD period is started, and the reference signal output circuit 40 starts changing the potential of the reference signal Vramp. At this time, the reference signal selection unit 36 selects the reference signal Vramp_l as the reference signal Vramp in accordance with the low-level control signal ΦRamp_sel and the luminance identification signal J having a digital value of 0. Hereinafter, the reference signal Vramp_l used in the comparison process in the S_AD period is referred to as a reference signal Vramp_SL.

It is assumed that the potential of the reference signal Vramp_SL becomes lower than the potential of the image signal Vs1 at the subsequent time t62. As a result, a pulse of the latch signal ΦLt is generated, and the count value SL1 indicated by the counter signal Φcot at the time t62 is held in the memory 46S.

The count value SL1 held in the memory 46S is output to the horizontal transfer line 52S in response to the control signal Hi from the horizontal scanning circuit 60 and is transmitted to the DSP 70 as the digital signal DS. The count values NL1 and NH1 held in the memories 46NL and 46NH are output to the horizontal transfer lines 52NL and 52NH, respectively, in response to the control signal Hi from the horizontal scanning circuit 60 and are transmitted to the reference signal selection unit 54. The reference signal selection unit 54 selects the count value NL1 from among the count values NH1 and NL1 according to the luminance identification signal J of the digital value 0 held in the memory 44J and transmits the selected count value to the DSP 70 as the digital signal DN.

The determination unit 72 determines whether or not the signal level of the digital signal DN is in the high luminance blackening state. In the low-luminance normal light, the determination signal ΦCT becomes low-level according to the luminance identification signal J of 0. The difference processing unit 74 subtracts the digital signal DN from the digital signal DS according to the low-level determination signal ΦCT and outputs a difference value as the digital signal DS2.

Next, AD conversion processing and signal processing in the DSP 70 when incident light is high-luminance normal light will be described. A description of the same processing as that in the case where the incident light is the low-luminance normal light will be omitted as appropriate.

At the time t2, the vertical scanning circuit 20 controls the control signal ΦRes of the row to be read out from high-level to low-level. As a result, the reset transistor M2 of each of the pixels 12 in the row to be read out is turned off, and the reset state of the node FD is canceled. A signal obtained when the reset transistor M2 is turned off and the potential of the signal output line Yi is settled is referred to as a reference signal Vn2.

At the subsequent time t3, the TG 80 controls the control signal ΦAz from high-level to low-level. Accordingly, the reset state of the comparison circuit 34 is canceled, the potential of the input side terminal of the clamp capacitor Ci1 becomes the level of the reference signal Vn2, and the potential of the output side terminal of the clamp capacitor Ci1, that is, the potential of one input node of the comparator 38 is clamped to the potential of the reference signal Vn2. Further, the potential of the input side terminal of the clamp capacitor Ci2 becomes the level of the reference potential of the reference signal Vramp_h, and the potential of the output side terminal of the clamp capacitor Ci2, that is, the potential of the other input node of the comparator 38 is clamped to the same potential as the reference signal Vn2.

At the subsequent time t31, the above-described NH_AD period is started, and the reference signal output circuit 40 starts changing the potential of the reference signal Vramp_NH. The counter 50 starts the count operation in synchronization with the start of the change in the potential of the reference signal Vramp_NH.

It is assumed that the potential of the reference signal Vramp_NH becomes lower than the potential of the reference signal Vn2 at the subsequent time t32. As a result, a pulse of the latch signal ΦLt is generated, and the count value NH2 indicated by the counter signal Φcot at the time t32 is held in the memory 46NH.

At the subsequent time t41, the above-described NL_AD period is started, and the reference signal output circuit 40 starts changing the potential of the reference signal Vramp_NL. The counter 50 starts the count operation in synchronization with the start of the change in the potential of the reference signal Vramp_NL.

It is assumed that the potential of the reference signal Vramp_NL becomes lower than the potential of the reference signal Vn2 at the subsequent time t42. As a result, a pulse of the latch signal ΦLt is generated, and the count value NL2 indicated by the counter signal Φcot at the time t42 is held in the memory 46NL.

At the subsequent time t4, the vertical scanning circuit 20 controls the control signal ΦTx of the row to be read out from low-level to high-level. As a result, the transfer transistor M1 of each of the pixels 12 in the row to be read out is turned on, and the charge accumulated in the photoelectric conversion element PD is transferred to the node FD. The pixel signal Vpix corresponding to the amount of charge transferred to the node FD is output to the signal output line Yi.

At the subsequent time t5, the vertical scanning circuit 20 controls the control signal ΦTx of the row to be read out from high-level to low-level. As a result, the transfer transistor M1 of each of the pixels 12 in the row to be read out is turned off. A signal obtained when the transfer transistor M1 is turned off and the potential of the signal output line Yi is settled is referred to as an image signal Vs2.

At the subsequent time t6, the above-described JUDGE period is started, and the TG 80 controls the control signal ΦJudge supplied to the reference signal output circuit 40 from low-level to high-level in the period from the time t6 to the time t7. The reference signal output circuit 40 sets the reference signal Vramp_l to the determination voltage Vjudge in response to the high-level control signal ΦJudge. The reference signal selection unit 36 selects the reference signal Vramp_l (determination voltage Vjudge) as the reference signal Vramp in accordance with the low-level control signal ΦRamp_sel.

The comparison circuit 34 compares the level of the image signal Vs2 with the level of the determination voltage Vjudge. In the high-luminance normal light, since the potential of the determination voltage Vjudge is higher than the potential of the image signal Vs2, the output of the comparison circuit 34 is inverted, and a pulse of the latch signal ΦLt is generated. As a result, the digital value 1 is held as the luminance identification signal J in the memory 44J.

At the subsequent time t61, the above-described S_AD period is started, and the reference signal output circuit 40 starts changing the potential of the reference signal Vramp. At this time, the reference signal selection unit 36 selects the reference signal Vramp_h as the reference signal Vramp in accordance with the luminance identification signal J of the digital value 1. Hereinafter, the reference signal Vramp_h used in the comparison process in the S_AD period is referred to as a reference signal Vramp_SH.

It is assumed that the potential of the reference signal Vramp_SH becomes lower than the potential of the image signal Vs2 at the subsequent time t63. As a result, a pulse of the latch signal ΦLt is generated, and the count value SH2 indicated by the counter signal Φcot at the time t63 is held in the memory 46S.

The count value SH2 held in the memory 46S is output to the horizontal transfer line 52S in response to the control signal Hi from the horizontal scanning circuit 60 and is transmitted to the DSP 70 as the digital signal DS. The count values NL2 and NH2 held in the memories 46NL and 46NH are output to the horizontal transfer lines 52NL and 52NH, respectively, in response to the control signal Hi from the horizontal scanning circuit 60 and are transmitted to the reference signal selection unit 54. The reference signal selection unit 54 selects the count value NH2 from among the count values NH2 and NL2 according to the luminance identification signal J of the digital value 1 held in the memory 44J and transmits the selected count value to the DSP 70 as the digital signal DN.

The determination unit 72 determines whether or not the signal level of the digital signal DN is in the high luminance blackening state. In the high-luminance normal light, although the luminance identification signal J is 1, the determination signal ΦCT becomes low-level according to that the digital signal value of the digital signal DN is smaller than the determination value of the determination data DN_H. The difference processing unit 74 subtracts the digital signal DN from the digital signal DS according to the low-level determination signal ΦCT and outputs a difference value as the digital signal DS2.

Next, AD conversion processing and signal processing in the DSP 70 when incident light is excessive light will be described. A description of the same processing as that in the case where the incident light is the low-luminance normal light or the high-luminance normal light will be omitted as appropriate.

At the time t2, the vertical scanning circuit 20 controls the control signal ΦRes of the row to be read out from high-level to low-level. As a result, the reset transistor M2 of each of the pixels 12 in the row to be read out is turned off, and the reset state of the node FD is canceled. A signal obtained when the reset transistor M2 is turned off and the potential of the signal output line Yi is settled is referred to as a reference signal Vn3. Note that when excessive light is incident, charge leaks from the saturated photoelectric conversion element PD to the node FD, so that the level of the reference signal Vn3 becomes lower than the levels of the reference signals Vn1 and Vn2.

At the subsequent time t3, the TG 80 controls the control signal ΦAz from high-level to low-level. Accordingly, the reset state of the comparison circuit 34 is canceled, the potential of the input side terminal of the clamp capacitor Ci1 becomes the level of the reference signal Vn3, and the potential of the output side terminal of the clamp capacitor Ci1, that is, the potential of one input node of the comparator 38 is clamped to the potential of the reference signal Vn3. Further, the potential of the input side terminal of the clamp capacitor Ci2 becomes the level of the reference potential of the reference signal Vramp_h, and the potential of the output side terminal of the clamp capacitor Ci2, that is, the potential of the other input node of the comparator 38 is clamped to the same potential as the reference signal Vn3.

At the subsequent time t31, the above-described NH_AD period is started, and the reference signal output circuit 40 starts changing the potential of the reference signal Vramp_NH. The counter 50 starts the count operation in synchronization with the start of the change in the potential of the reference signal Vramp_NH.

It is assumed that the potential of the reference signal Vramp_NH becomes lower than the potential of the reference signal Vn3 at the subsequent time t33. As a result, a pulse of the latch signal ΦLt is generated, and the count value NH3 indicated by the counter signal Φcot at the time t33 is held in the memory 46NH.

At the subsequent time t41, the above-described NL_AD period is started, and the reference signal output circuit 40 starts changing the potential of the reference signal Vramp_NL. The counter 50 starts the count operation in synchronization with the start of the change in the potential of the reference signal Vramp_NL.

It is assumed that the potential of the reference signal Vramp_NL becomes lower than the potential of the reference signal Vn3 at the subsequent time t43. As a result, a pulse of the latch signal ΦLt is generated, and the count value NL3 indicated by the counter signal Φcot at the time t43 is held in the memory 46NL.

At the subsequent time t4, the vertical scanning circuit 20 controls the control signal ΦTx of the row to be read out from low-level to high-level. As a result, the transfer transistor M1 of each of the pixels 12 in the row to be read out is turned on, and the charge accumulated in the photoelectric conversion element PD is transferred to the node FD. The pixel signal Vpix corresponding to the amount of charge transferred to the node FD is output to the signal output line Yi.

At the subsequent time t5, the vertical scanning circuit 20 controls the control signal ΦTx of the row to be read out from high-level to low-level. As a result, the transfer transistor M1 of each of the pixels 12 in the row to be read out is turned off. A signal obtained when the transfer transistor M1 is turned off and the potential of the signal output line Yi is settled is referred to as an image signal Vs3.

At the subsequent time t6, the above-described JUDGE period is started, and the TG 80 controls the control signal ΦJudge supplied to the reference signal output circuit 40 from low-level to high-level in the period from the time t6 to the time t7. The reference signal output circuit 40 sets the reference signal Vramp_l to the determination voltage Vjudge in response to the high-level control signal ΦJudge. The reference signal selection unit 36 selects the reference signal Vramp_l (determination voltage Vjudge) as the reference signal Vramp in accordance with the low-level control signal ΦRamp_sel.

The comparison circuit 34 compares the level of the image signal Vs3 with the level of the determination voltage Vjudge. In the case of excessive light, according to that the potential of the determination voltage Vjudge is higher than the potential of the image signal Vs3, the output of the comparison circuit 34 is inverted, and a pulse of the latch signal ΦLt is generated. As a result, the digital value 1 is held as the luminance identification signal J in the memory 44J.

At the subsequent time t61, the above-described S_AD period is started, and the reference signal output circuit 40 starts changing the potential of the reference signal Vramp. At this time, the reference signal selection unit 36 selects the reference signal Vramp_h (Vramp_SH) as the reference signal Vramp in accordance with the luminance identification signal J of the digital value 1.

At the subsequent time t64, the potential of the reference signal Vramp_SH transitions to the minimum value, but the potential of the reference signal Vramp_SH does not fall below the potential of the image signal Vs3. As a result, the pulse of the latch signal ΦLt is not generated, and the count value SH3, which is the upper limit count value of the counter 50, is held in the memory 46S.

The count value SH3 held in the memory 46S is output to the horizontal transfer line 52S in response to the control signal Hi from the horizontal scanning circuit 60 and is transmitted to the DSP 70 as the digital signal DS. The count values NL3 and NH3 held in the memories 46NL and 46NH are output to the horizontal transfer lines 52NL and 52NH, respectively, in response to the control signal Hi from the horizontal scanning circuit 60 and are transmitted to the reference signal selection unit 54. The reference signal selection unit 54 selects the count value NH3 from among the count values NH3 and NL3 according to the luminance identification signal J of the digital value 1 held in the memory 44J and transmits the selected count value to the DSP 70 as the digital signal DN.

The determination unit 72 determines whether or not the signal level of the digital signal DN is in the high luminance blackening state. In the high-luminance normal light, the determination signal ΦCT becomes high-level according to that the luminance identification signal J is 1 and the digital signal value of the digital signal DN is larger than the determination value of the determination data DN_H. In response to the high-level determination signal ΦCT, the difference processing unit 74 outputs a blackening correction value corresponding to the white level as the digital signal DS2, instead of the difference value between the digital signal DS and the digital signal DN.

As described above, by performing the saturation determination of the photoelectric conversion element PD according to the signal levels of the luminance identification signal J and the digital signal DN, it is possible to appropriately determine the blackening state and correct the digital signal DS2 to the white level. If the blackening correction is performed using only the digital signal DN without using the luminance identification signal J, the count value NL of the reference signal on the low luminance side is larger than the count value NH of the reference signal on the high luminance side by the gain ratio. Therefore, when a value slightly larger than the count value NH of the high luminance is set as the determination data DN_H, the count value NL becomes larger than the determination data DN_H despite the fact that the amount of incident light is low, and as a result, the luminance linearity is lost as a result of the blackening correction being erroneously performed. In this case, the above problem can be avoided by setting a value larger than the count value NL of the low-luminance reference signal as the determination data DN_H. However, since the correction is enabled after the count value NH of the reference signal becomes larger than expected at the time of excessive light incidence, the blackening correction becomes effective after the blackening occurs, and appropriate correction cannot be performed. In this regard, in the present embodiment, since the blackening correction is enabled only at the time of high luminance by using the luminance identification signal J, it is possible to perform the blackening correction more suitably than the conventional method.

As described above, according to the present embodiment, even in a case where pixel signals are processed using a plurality of different gain settings, it is possible to obtain a good quality image by performing appropriate blackening correction.

### Second Embodiment

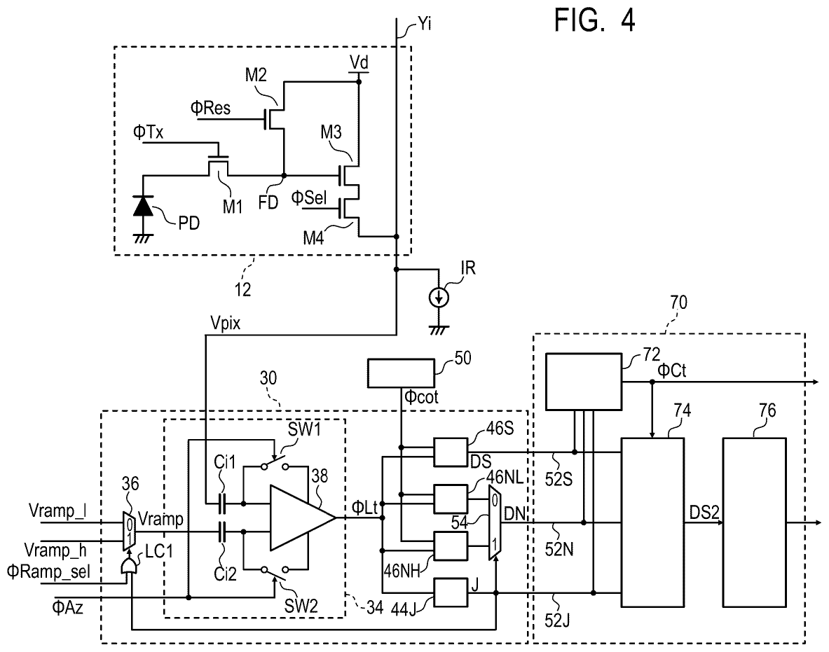

A photoelectric conversion device according to a second embodiment will be described with reference to FIG. 4. The same components as those of the photoelectric conversion device according to the first embodiment are denoted by the same reference numerals, and description thereof will be omitted or simplified. FIG. 4 is a block diagram illustrating a schematic configuration of the photoelectric conversion device according to the present embodiment.

In the first embodiment, the configuration and the method of performing the high-luminance blackening correction using the luminance identification signal J and the digital signal DN have been described. In the present embodiment, a configuration and a method for performing high-luminance blackening correction in which the digital signal DS is further used in addition to the luminance identification signal J and the digital signal DN are described.

In the photoelectric conversion device according to the present embodiment, as illustrated in FIG. 4, the determination unit 72 is connected to the horizontal transfer line 52N in addition to the horizontal transfer lines 52S and 52J. Other points are the same as those of the photoelectric conversion device according to the first embodiment.

In the first embodiment, the high-luminance blackening correction is performed using the luminance identification signal J and the digital signal DN, but when the correction process is performed using only the digital signal DN, the high-luminance blackening correction may not operate as expected.

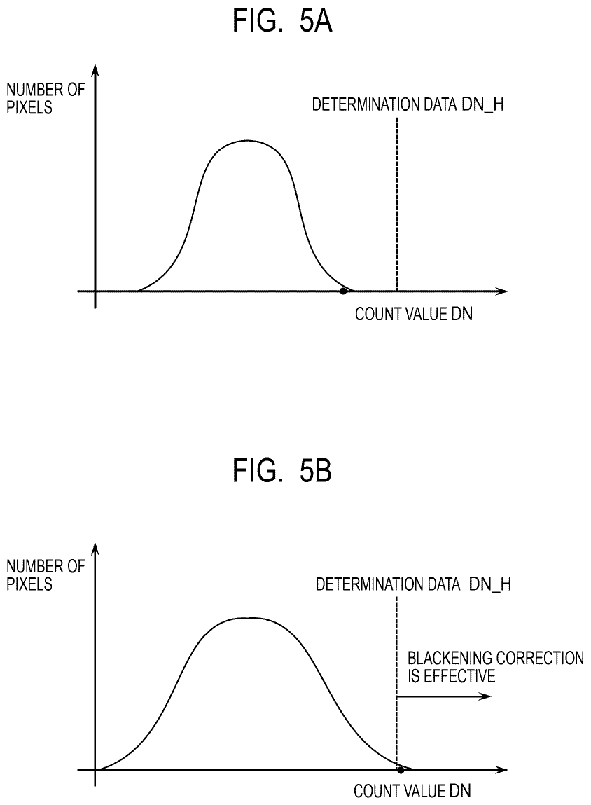

FIG. 5A and FIG. 5B are diagrams schematically illustrating a distribution of count values of the digital signal DN in a state where normal light other than excessive light is incident. In FIG. 5A and FIG. 5B, the horizontal axis represents the count value of the digital signal DN, and the vertical axis represents the number of pixels. When excessive light is incident, the count value of the digital signal DN becomes larger than the value of the determination data DN_H and is a correction target.

The count value of the digital signal DN varies for each pixel 12 and has a distribution as illustrated in FIG. 5A, for example. Normally, in a state where normal light other than excessive light is incident, the count value of the digital signal DN in each pixel 12 is lower than the value of the determination data DN_H. However, depending on the pixel 12, the count value of the digital signal DN may become a large value such that the count value does not slightly exceed the value of the determination data DN_H even in a state in which light is not incident, due to the influence of, for example, a flaw in the manufacturing process (see the black circle in FIG. 5A).

Further, in the AD conversion of the pixel signal, the variation of the reference signal may increase due to the influence of the temperature at the time of photographing or various kinds of noise, and the distribution of the count value of the digital signal DN may be wider than the distribution of FIG. 5A as illustrated in FIG. 5B, for example. In this case, there is a possibility that the count value of the pixel 12 having the count value indicated by the above-described black circle further increases and exceeds the value of the determination data DN_H despite the non-saturation state. As a result, unintended blackening correction is performed regardless of the amount of incident light, resulting in a white pixel that outputs a white level regardless of the amount of incident light, which leads to a decrease in yield and image quality.

From such a viewpoint, in the present embodiment, in addition to the luminance identification signal J and the digital signal DN, the digital signal DS is used for the determination of the high-luminance blackening correction. That is, in the present embodiment, the digital signal DN is compared with the determination data DN_H, and further, the digital signal value of the digital signal DS is compared with the determination value of the determination data DS_H. Here, the determination data DS_H is determined based on the value of the digital signal DS obtained when the photoelectric conversion element PD is saturated and may be set to, for example, a white level value slightly smaller than the saturation state of the digital signal DS at the time of high luminance. As in the first embodiment, the determination data DN_H may be set to a value slightly larger than the count value of the digital signal DN at the time of high luminance in consideration of variations. When the luminance identification signal J indicates high luminance and the digital signals DN and DS are greater than or equal to the determination data DN_H and DS_H, respectively, the high luminance blackening correction is enabled.

In other words, in a case where the luminance identification signal J is 1, the value of the digital signal DN is equal to or greater than the determination value of the determination data DN_H, and the value of the digital signal DS is equal to or greater than the determination value of the determination data DS_H, the difference processing unit 74 outputs a second value corresponding to the white level. In other cases, the difference processing unit 74 outputs a first value that is a difference value obtained by subtracting the digital signal DN from the digital signal DS.

In the present embodiment, when the amount of incident light is excessive light, the luminance identification signal J becomes a digital value 1 indicating high luminance, the digital signal DN exceeds the determination data DN_H, and the digital signal DS also exceeds the determination data DS_H, so that the high luminance blackening correction is performed. On the other hand, when the amount of high-luminance light, which is not excessively large, is incident on the pixel 12, the luminance identification signal J has a digital value of 1 indicating high luminance. The digital signal DN becomes larger than the determination data DN_H due to the influence of the increase in the variation amount. Since the digital signal DS is in the non-saturated state, the digital signal DS becomes smaller than the determination data DS_H. As a result, the high-luminance blackening correction is not performed. When the amount of incident light is small and the luminance identification signal J has a digital value of 0, the high-luminance blackening correction is not performed. Therefore, it is possible to suppress unintended blackening correction processing when a low amount of light is incident by performing high-luminance blackening determination using also the digital signal DS.

The malfunction of the blackening correction may be suppressed by increasing the determination data DN_H in consideration of the variation increasing process in the first embodiment. However, in this case, the detection luminance of the blackening becomes larger than expected. According to the present embodiment, the blackening correction may be performed more suitably.

As described above, according to the present embodiment, even in a case where pixel signals are processed using a plurality of different gain settings, it is possible to obtain a good quality image by performing appropriate blackening correction.

### Third Embodiment

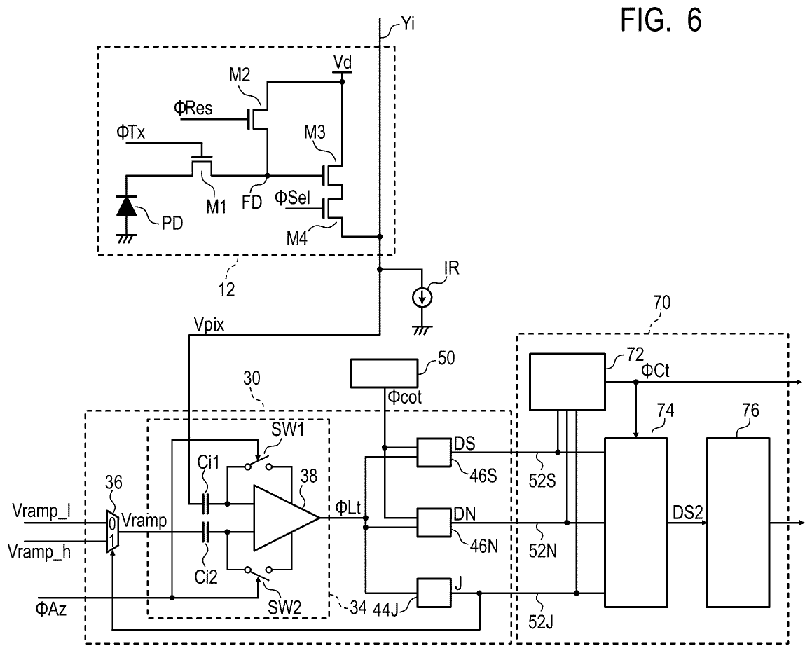

A photoelectric conversion device according to a third embodiment will be described with reference to FIG. 6. The same components as those of the photoelectric conversion devices according to the first and second embodiments are denoted by the same reference numerals, and description thereof will be omitted or simplified. FIG. 6 is a block diagram illustrating a schematic configuration of the photoelectric conversion device according to the present embodiment.

In the first and second embodiments, in the dual slope AD conversion, AD conversion is performed on the reference signal Vn twice using the reference signals Vramp_l and Vramp_h, and one is output as the digital signal DN based on the luminance identification signal J. In the present embodiment, one AD conversion is performed on the reference signal Vn using the reference signal Vramp_l.

As illustrated in FIG. 6, the photoelectric conversion device according to the present embodiment is different from the photoelectric conversion device according to the second embodiment in that the reference signal selection unit 36 is controlled based only on the luminance identification signal J, and a memory 46N is provided instead of the memories 46NL and 46NH. That is, the photoelectric conversion device according to the present embodiment does not include the OR circuit LC1 and the reference signal selection unit 54 and does not use the control signal ΦRamp_sel as the control signal of the reference signal selection unit 36. A first input node of the memory 46N is connected to an output node of the comparison circuit 34. A second input node of the memory 46N is connected to the counter 50. A third input node of the memory 46N is connected to the horizontal scanning circuit 60. An output node of the memory 46N is connected to the horizontal transfer line 52N.

The difference processing unit 74 includes a correction circuit that corrects the count value of the digital signal DN according to the luminance identification signal J. When the luminance identification signal J has a digital value of 0, the count value of the input digital signal DN is used. When the luminance identification signal J has a digital value of 1, the count value of the digital signal DN is corrected by the difference between the slopes of the reference signals Vramp_l and Vramp_h, that is, by the gain ratio. Then, a difference process is performed between the count value of the digital signal DS and the gain ratio correction result of the count value of the digital signal DN to output as the digital signal DS2. The signal processing unit 76 may further perform linearity correction processing for correcting a gain ratio or offset deviation between the low luminance signal and the high luminance signal generated for each column circuit unit.

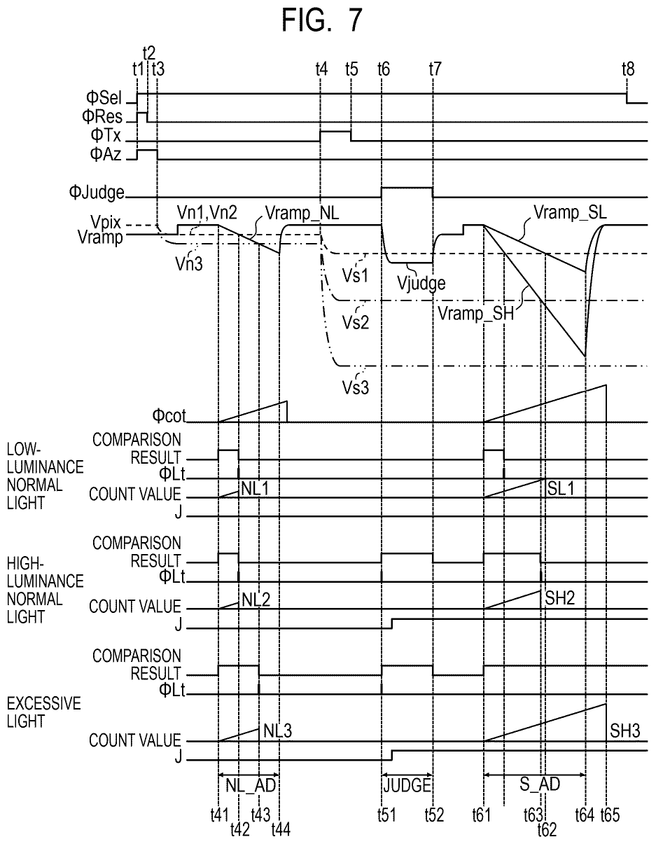

Next, a method of driving the photoelectric conversion device according to the present embodiment will be described with reference to FIG. 7. FIG. 7 is a timing chart illustrating a method of driving the photoelectric conversion device according to the present embodiment. In FIG. 7, the horizontal direction indicates time, and the vertical direction indicates a schematic waveform of each signal. In the present embodiment, in the AD conversion period of the reference signal Vn, the AD conversion period (NH_AD period) using the reference signal Vramp_h is not performed, and only the AD conversion period (NL_AD period) using the reference signal Vramp_h is performed. The other points are basically the same as those of the driving method of the first embodiment described with reference to FIG. 3. Description of processing similar to that of the driving method of the first embodiment will be omitted as appropriate.

At the time t41, the NL_AD period starts, and the reference signal output circuit 40 starts changing the potential of the reference signal Vramp_NL. The counter 50 starts the count operation in synchronization with the start of the change in the potential of the reference signal Vramp_NL. When the potential of the reference signal Vramp_NL becomes lower than the potential of the reference signal Vn (Vn1, Vn2, Vn3), a pulse of the latch signal ΦLt is generated, and the count value NL (NL1, NL2, NL3) indicated by the counter signal Φcot at that time is held in the memory 46N.

At the subsequent time t51, the JUDGE period starts, the reference signal Vramp (reference signal Vramp_SL or reference signal Vramp_SH) used for AD conversion of the image signal Vs is selected, and the comparison result is held in the memory 44J.

At the subsequent time t61, the S-AD period starts, and the potential of the reference signal Vramp selected in the JUDGE period starts to change. The counter 50 starts the count operation in synchronization with the start of the change in the potential of the reference signal Vramp. When the potential of the reference signal Vramp becomes lower than the potential of the image signal Vs (Vs1, Vs2, Vs3), a pulse of the latch signal ΦLt is generated, and the count values SL and SH (SL1, SH2, SH3) indicated by the counter signal Φcot at that time are held in the memory 46S.

The high-luminance blackening correction in the DSP 70 may be performed in the same manner as in the first or second embodiment using the digital signals DN and DS and the luminance identification signal J.

As described above, according to the present embodiment, even in a method in which one AD conversion is performed with respect to the reference voltage in the dual slope AD conversion, it is possible to obtain a good-quality image by performing appropriate blackening correction.

### Fourth Embodiment

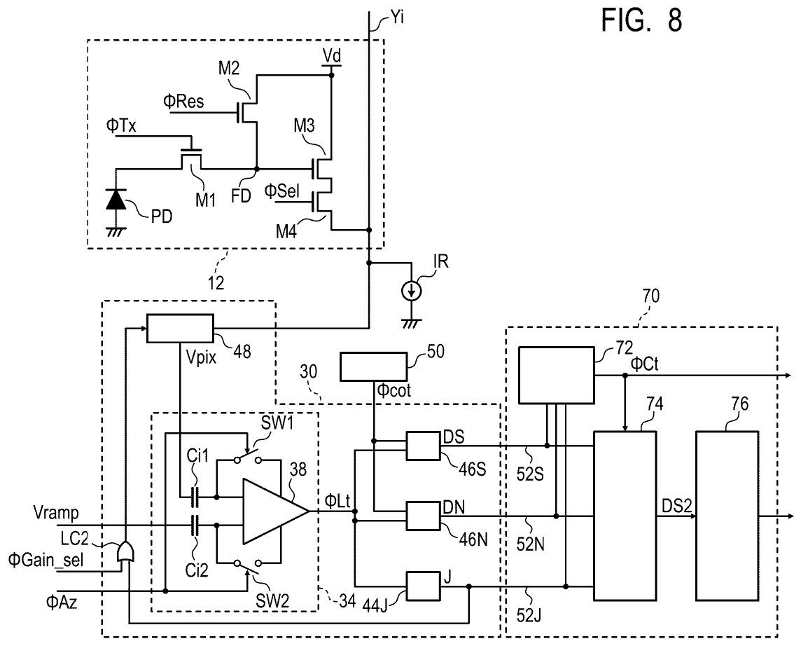

A photoelectric conversion device according to a fourth embodiment will be described with reference to FIG. 8. The same components as those of the photoelectric conversion devices according to the first to third embodiments are denoted by the same reference numerals, and description thereof will be omitted or simplified. FIG. 8 is a block diagram illustrating a schematic configuration of the photoelectric conversion device according to the present embodiment.

In the first to third embodiments, AD conversion results having different gain ratios are obtained by using ramp signals having different slopes. In the present embodiment, a method of obtaining AD conversion results having different gain ratios by performing AD conversion after performing analog amplification processing having different gain ratios on analog signals output from the pixels 12 will be described.

As illustrated in FIG. 8, the photoelectric conversion device according to the present embodiment further includes an amplifier circuit 48 connected between the signal output line Yi and the comparison circuit 34. The amplifier circuit 48 performs gain processing on the output voltage of the pixel 12 in accordance with the control signal ΦGain_sel and the luminance identification signal J from the TG 80 and outputs the pixel signal Vpix after the gain processing to the comparison circuit 34.

The control signal ΦGain_sel and the luminance identification signal J are input to the control node of the amplifier circuit 48 via the OR circuit LC2. Accordingly, when the control signal ΦGain_sel and the luminance identification signal J are at low-level, the amplifier circuit 48 performs gain processing (gain processing for low luminance) on the output voltage of the pixel 12 with the first gain. When at least one of the control signal ΦGain_sel and the luminance identification signal J is at high-level, the amplifier circuit 48 performs gain processing (gain processing for high luminance) on the output voltage of the pixel 12 with a second gain smaller than the first gain.

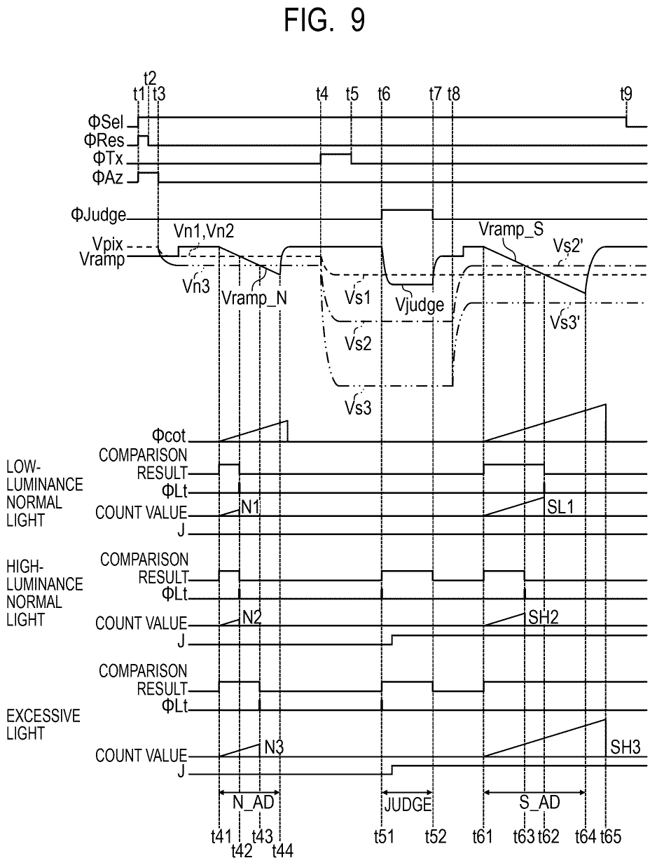

Next, a method of driving the photoelectric conversion device according to the present embodiment will be described with reference to FIG. 9. FIG. 9 is a timing chart illustrating a method of driving the photoelectric conversion device according to the present embodiment. In FIG. 9, the horizontal direction indicates time, and the vertical direction indicates a schematic waveform of each signal. In the present embodiment, in the AD conversion period of the reference signal Vn, AD conversion is performed on the reference signal Vn subjected to the gain processing for high luminance. In the AD conversion period of the image signal Vs, the AD conversion is performed on the image signal Vs subjected to the gain processing selected in the JUDGE period among the high-luminance gain processing and the low-luminance gain processing. The other points are basically the same as those of the driving method of the first embodiment described with reference to FIG. 3. Description of processing similar to that of the driving method of the first embodiment will be omitted as appropriate.

In FIG. 9, the period from time t41 to time t44 is an AD conversion period (N_AD conversion period) of the reference signal Vn subjected to the gain processing with the low luminance gain. A period from time t51 to time t52 is a determination period (JUDGE period) of the pixel signal Vpix using the determination voltage Vjudge. A period from time t61 to time t64 is an AD conversion period (S_AD period) of the image signal Vs.

In the N_AD period, the comparison circuit 34 performs a comparison process between the reference signal Vn and the reference signal Vramp which have been subjected to the low-luminance gain process in the amplifier circuit 48. When the N_AD period starts at time t41, the reference signal output circuit 40 starts changing the potential of the reference signal Vramp (Vramp_N). The counter 50 starts the count operation in synchronization with the start of the change in the potential of the reference signal Vramp_N. When the potential of the reference signal Vramp_N becomes lower than the potential of the reference signal Vn (Vn1, Vn2, Vn3), a pulse of the latch signal ΦLt is generated, and the count value N (N1, N2, N3) indicated by the counter signal Φcot at that time is held in the memory 46N.

In the JUDGE period, the comparison circuit 34 compares the image signal Vs subjected to the low-luminance gain processing in the amplifier circuit 48 with the determination voltage Vjudge. When the magnitude relationship between the potential of the pixel signal Vpix and the potential of the determination voltage Vjudge is inverted, the comparison circuit 34 generates the latch signal ΦLt based on the comparison result and holds the comparison result in the memory 44J. The amplifier circuit 48 selects a gain to be used in the S_AD period according to the luminance identification signal J indicating the comparison result and performs gain processing on the output voltage of the pixel 12.

For example, in FIG. 9, since the image signal Vs1 is not lower than the determination voltage Vjudge when the low-luminance normal light is incident, the amplifier circuit 48 performs the low-luminance gain processing on the image signal Vs1. In a case where the low luminance gain processing is selected, the gain is not changed from the JUDGE period, and thus the S_AD period is performed for the image signal Vs1. In a case where the high-luminance normal light or the excessive light is incident, the image signals Vs2 and Vs3 are lower than the determination voltage Vjudge, so that the amplifier circuit 48 performs the high-luminance gain processing so as to narrow the amplitude of the image signals Vs2 and Vs3. When the high-luminance gain processing is selected, the gain processing for the image signals Vs2 and Vs3 is changed from the low-luminance gain processing to the high-luminance gain processing. The image signals Vs2 and Vs3 obtained when the high-luminance gain processing is performed are referred to as image signals Vs2′ and Vs3′.

In the S_AD period, the comparison circuit 34 compares the image signal Vs subjected to the gain processing in the amplifier circuit 48 with the reference signal Vramp. When the S_AD period is started at time t61, the reference signal output circuit 40 starts changing the potential of the reference signal Vramp (Vramp_S). The counter 50 starts the count operation in synchronization with the start of the change in the potential of the reference signal Vramp_S. When the potential of the reference signal Vramp_S becomes lower than the potential of the image signal Vs (Vs1, Vs2′, Vs3′), a pulse of the latch signal ΦLt is generated, and the count value S (SL1, SH2, SH3) indicated by the counter signal Φcot at that time is held in the memory 46S.

As in the first or second embodiment, the determination unit 72 performs the blackening determination process using the digital signals DS and DN and the luminance identification signal J output from the memories 46S, 46N, and 44J. As a result of the determination, when the incident light amount is excessive light, the determination unit 72 outputs the correction signal ΦCt to the difference processing unit 74.

The difference processing unit 74 performs a luminance correction process and a difference calculation on the digital signals DS and DN based on the luminance identification signal J. In a case where the correction signal ΦCt output from the determination unit 72 is invalid (low-level), the difference processing unit 74 outputs the difference calculation result to the signal processing unit 76. On the other hand, in a case where the correction signal ΦCt is valid (high-level), the difference processing unit 74 outputs the white level correction value to the signal processing unit 76 instead of the difference calculation result.

As described above, the blackening correction processing according to the present embodiment may be performed not only for the AD conversion method by changing the slope of the reference signal as in the first and second embodiments, but also for the AD conversion method in which the gain of the amplifier circuit is variable. Similarly, even when an AD conversion method using the luminance identification signal other than the above-described method is used, the blackening correction process may be performed by performing the threshold determination using the AD conversion result and the luminance identification signal as in the present disclosure.

As described above, according to the present embodiment, even in a case where pixel signals are processed using a plurality of different gain settings, it is possible to obtain a good quality image by performing appropriate blackening correction.

### Fifth Embodiment

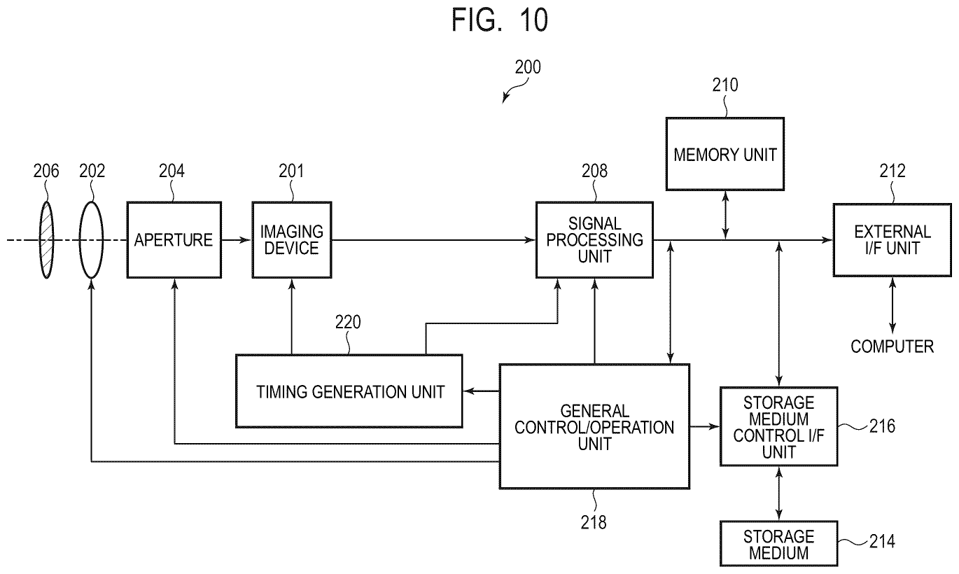

An imaging system according to a fifth embodiment will be described with reference to FIG. 10. FIG. 10 is a block diagram illustrating a schematic configuration of an imaging system according to the present embodiment.

The photoelectric conversion devices 100 described in the first to fourth embodiments may be applied to various imaging systems. Examples of applicable imaging systems include digital still cameras, digital camcorders, surveillance cameras, copying machines, facsimiles, mobile phones, on-vehicle cameras, observation satellites, and the like. A camera module including an optical system such as a lens and an imaging device is also included in the imaging system. FIG. 10 exemplifies a block diagram of a digital still camera as one of these.

The imaging system 200 illustrated in FIG. 10 includes an imaging device 201, a lens 202 that forms an optical image of an object on the imaging device 201, an aperture 204 that changes the amount of light passing through the lens 202, and a barrier 206 that protects the lens 202. The lens 202 and the aperture 204 constitute an optical system that focuses light onto the imaging device 201. The imaging device 201 is the photoelectric conversion device 100 described in any one of the first to fourth embodiments and converts the optical image formed by the lens 202 into image data.

The imaging system 200 further includes a signal processing unit 208 that processes an output signal output from the imaging device 201. The signal processing unit 208 generates image data from the digital signal output from the imaging device 201. Further, the signal processing unit 208 performs various corrections and compressions as necessary and outputs the processed image data. The imaging device 201 may include an AD conversion unit that generates a digital signal to be processed by the signal processing unit 208. The AD conversion unit may be formed on a semiconductor layer (semiconductor substrate) in which the photoelectric conversion unit of the imaging device 201 is formed or may be formed on a semiconductor layer (semiconductor substrate) different from the semiconductor layer in which the photoelectric conversion unit of the imaging device 201 is formed. The signal processing unit 208 may be formed on the same semiconductor layer (semiconductor substrate) as the imaging device 201.

The imaging system 200 further includes a memory unit 210 for temporarily storing image data and an external interface unit (external I/F unit) 212 for communicating with an external computer or the like. The imaging system 200 further includes a storage medium 214 such as a semiconductor memory for performing storing or reading out of imaging data, and a storage medium control interface unit (storage medium control I/F unit) 216 for performing storing on or reading out from the storage medium 214. Note that the storage medium 214 may be built in the imaging system 200 or may be detachable.

The imaging system 200 further includes a general control/operation unit 218 that performs various calculations and controls the entire digital still camera, and a timing generation unit 220 that outputs various timing signals to the imaging device 201 and the signal processing unit 208. Here, the timing signal or the like may be input from the outside, and the imaging system 200 may include at least the imaging device 201 and the signal processing unit 208 that processes the output signal output from the imaging device 201.

The imaging device 201 outputs an imaging signal to the signal processing unit 208. The signal processing unit 208 performs predetermined signal processing on the imaging signal output from the imaging device 201 and outputs the processed image data. The signal processing unit 208 generates an image using the imaging signal.

As described above, according to the present embodiment, it is possible to realize an imaging system to which the photoelectric conversion device 100 according to any one of the first to fourth embodiments is applied.

### Sixth Embodiment

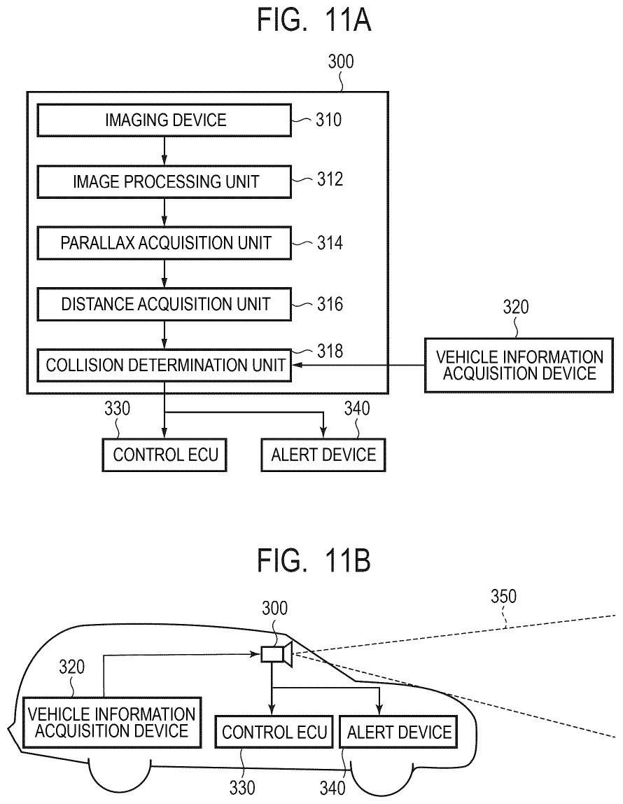

An imaging system and a movable object according to a sixth embodiment will be described with reference to FIG. 11A and FIG. 11B. FIG. 11A is a diagram illustrating a configuration of an imaging system according to the present embodiment. FIG. 11B is a diagram illustrating a configuration of a movable object according to the present embodiment.

FIG. 11A illustrates an example of an imaging system related to an on-vehicle camera. The imaging system 300 includes an imaging device 310. The imaging device 310 is the photoelectric conversion device 100 according to any one of the first to fourth embodiments. The imaging system 300 includes an image processing unit 312 that performs image processing on a plurality of image data acquired by the imaging device 310, and a parallax acquisition unit 314 that calculates parallax (phase difference of parallax images) from the plurality of image data acquired by the imaging device 310. The imaging system 300 further includes a distance acquisition unit 316 that calculates a distance to an object based on the calculated parallax, and a collision determination unit 318 that determines whether there is a collision possibility based on the calculated distance. Here, the parallax acquisition unit 314 and the distance acquisition unit 316 are examples of a distance information acquisition unit that acquires distance information to the object. That is, the distance information is information related to a parallax, a defocus amount, a distance to the object, and the like. The collision determination unit 318 may determine the collision possibility using any of the distance information. The distance information acquisition unit may be realized by dedicatedly designed hardware or may be realized by a software module. Further, it may be realized by a field programmable gate array (FPGA), an application specific integrated circuit (ASIC), or the like, or may be realized by a combination of these.

The imaging system 300 is connected to a vehicle information acquisition device 320 and may acquire vehicle information such as a vehicle speed, a yaw rate, and a steering angle. Further, the imaging system 300 is connected to a control ECU 330 which is a control device that outputs a control signal for generating a braking force to the vehicle based on the determination result of the collision determination unit 318. The imaging system 300 is also connected to an alert device 340 that issues an alert to the driver based on the determination result of the collision determination unit 318. For example, when the determination result of the collision determination unit 318 indicates that the possibility of collision is high, the control ECU 330 performs vehicle control to avoid collision and reduce damage by, for example, applying a brake, returning an accelerator, or suppressing engine output. The alert device 340 gives an alert to the user by sounding an alarm such as a sound, displaying alert information on a screen of a car navigation system or the like, giving vibration to a seat belt or a steering wheel, or the like.

In the present embodiment, an image of the surroundings of the vehicle, for example, the front or the rear is captured by the imaging system 300. FIG. 11B illustrates the imaging system in a case where an image in front of the vehicle (imaging range 350) is captured. The vehicle information acquisition device 320 sends instructions to the imaging system 300 or the imaging device 310. With such configuration, the accuracy of distance measurement may be further improved.

Although an example in which control is performed so as not to collide with another vehicle has been described above, the present disclosure is also applicable to control in which automatic driving is performed so as to follow another vehicle, control in which automatic driving is performed so as not to protrude from a lane, and the like. Further, the imaging system is not limited to a vehicle such as an own vehicle and may be applied to, for example, other movable objects (mobile devices), such as, for example, a ship, an aircraft, an industrial robot, or the like. In addition, the present disclosure is not limited to the movable object and may be widely applied to equipment using object recognition, such as an intelligent transport systems (ITS).

### Seventh Embodiment

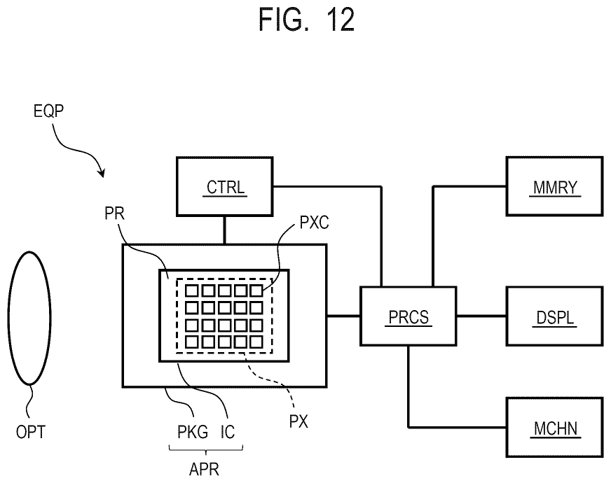

An equipment according to a seventh embodiment will be described with reference to FIG. 12. FIG. 12 is a block diagram illustrating a schematic configuration of an equipment according to the present embodiment.

FIG. 12 is a schematic diagram illustrating an equipment EQP including a photoelectric conversion device APR. The photoelectric conversion device APR has the function of the photoelectric conversion device 100 according to any one of the first to fourth embodiments. All or part of the photoelectric conversion device APR is a semiconductor device IC. The photoelectric conversion device APR of the present example may be used as, for example, an image sensor, an auto focus (AF) sensor, a photometric sensor, or a distance measurement sensor. The semiconductor device IC includes a pixel region PX in which pixel circuits PXC each including a photoelectric conversion unit are arranged in a matrix. The semiconductor device IC may include a peripheral region PR around the pixel region PX. A circuit other than the pixel circuit may be arranged in the peripheral region PR.

The photoelectric conversion device APR may have a structure (chip stacked structure) in which a first semiconductor chip provided with a plurality of photoelectric conversion units and a second semiconductor chip provided with peripheral circuits are stacked. Each of the peripheral circuits in the second semiconductor chip may be a column circuit corresponding to a pixel column of the first semiconductor chip. The peripheral circuits in the second semiconductor chip may be matrix circuits corresponding to pixels or pixel blocks in the first semiconductor chip. As the connection between the first semiconductor chip and the second semiconductor chip, a through electrode (through silicon via (TSV)), an inter-chip wiring by direct bonding of a conductor such as copper, a connection by a micro bump between the chips, a connection by wire bonding, or the like may be employed.

The photoelectric conversion device APR may include a package PKG that accommodates the semiconductor device IC in addition to the semiconductor device IC. The package PKG may include a base body to which the semiconductor device IC is fixed, a lid body such as glass facing the semiconductor device IC, and a connection members such as bonding wires or bumps for connecting terminals provided on the base body and terminals provided on the semiconductor device IC.

The equipment EQP may further include at least one of an optical device OPT, a control device CTRL, a processing device PRCS, a display device DSPL, a storage device MMRY, and a mechanical device MCHN. The optical device OPT corresponds to the photoelectric conversion device APR as a photoelectric conversion device, and is, for example, a lens, a shutter, or a mirror. The control device CTRL controls the photoelectric conversion device APR and is, for example, a semiconductor device such as an ASIC. The processing device PRCS processes a signal output from the photoelectric conversion device APR and constitutes an analog front end (AFE) or a digital front end (DFE). The processing unit PRCS is a semiconductor device such as a central processing unit (CPU) or an ASIC. The display device DSPL may be an electroluminescent (EL) display device or a liquid crystal display device that displays information (image) obtained by the photoelectric conversion device APR. The storage device MMRY may be a magnetic device or a semiconductor device that stores information (image) obtained by the photoelectric conversion device APR. The storage device MMRY may be a volatile memory such as a static random access memory (SRAM) or a dynamic random access memory (DRAM), or a nonvolatile memory such as a flash memory or a hard disk drive. The mechanical device MCHN may include a movable portion or a propulsion portion such as a motor or an engine. In the equipment EQP, a signal output from the photoelectric conversion device APR is displayed on the display device DSPL or transmitted to the outside by a communication device (not illustrated) included in the equipment EQP. Therefore, it is preferable that the equipment EQP further includes a storage device MMRY and a processing device PRCS separately from the storage circuit unit and the arithmetic circuit unit included in the photoelectric conversion device APR.

The equipment EQP illustrated in FIG. 12 may be an electronic device such as an information terminal (for example, a smartphone or a wearable terminal) having a photographing function or a camera (for example, an interchangeable lens camera, a compact camera, a video camera, and a monitoring camera). The mechanical device MCHN in the camera may drive components of the optical device OPT for zooming, focusing, and shutter operation. The equipment EQP may be a transportation device (movable object) such as a vehicle, a ship, or an aircraft. The equipment EQP may be a medical device such as an endoscope or a CT scanner.

The mechanical device MCHN in the transportation device may be used as a mobile device. The equipment EQP as a transportation device is suitable for transporting the photoelectric conversion device APR, or for assisting and/or automating operation (manipulation) by an imaging function. The processing device PRCS for assisting and/or automating driving (manipulation) may perform processing for operating the mechanical device MCHN as a moving device based on information obtained by the photoelectric conversion device APR.

The photoelectric conversion device APR according to the present embodiment may provide a high value to a designer, a manufacturer, a seller, a purchaser, and/or a user thereof. Therefore, when the photoelectric conversion device APR is mounted on the equipment EQP, the value of the equipment EQP may also be increased. Therefore, in manufacturing and selling the equipment EQP, it is advantageous to determine the mounting of the photoelectric conversion device APR of the present embodiment on the equipment EQP in order to increase the value of the equipment EQP.

### Modified Embodiments

The present disclosure is not limited to the above embodiments, and various modifications are possible.

For example, an example in which a part of the configuration of any of the embodiments is added to another embodiment or an example in which a part of the configurations of any of the embodiments is substituted with some of the configurations of another embodiment is also an embodiment of the present disclosure.

The circuit configuration of the pixel 12 illustrated in FIG. 2 is an example and may be appropriately changed. For example, each pixel 12 may include two or more photoelectric conversion elements. In this case, the plurality of photoelectric conversion elements may share one floating diffusion (node FD). Alternatively, a pupil division pixel in which the plurality of photoelectric conversion elements share one microlens may be used so that a phase difference may be detected. In addition, the pixel 12 does not necessarily have to include the select transistor M4. The capacitance value of the node FD may be switchable.

Although one column circuit unit is provided in each column of the pixel unit 10 in the above-described embodiments, one column circuit unit may be provided for a plurality of columns of the pixel unit 10, or a plurality of column circuit units may be provided in each column of the pixel unit 10. These examples are also included in the form in which each of the plurality of column circuit units is arranged corresponding to the column in which the pixel 12 is arranged.

Further, in the above-described embodiments, an example in which the technology of the present disclosure is applied to a photoelectric conversion device including a slope-type AD conversion circuit has been described, but the AD conversion circuit included in the photoelectric conversion device does not necessarily need to be a slope-type AD conversion circuit. The technology of the present disclosure may be applied not only to a photoelectric conversion device having a slope-type AD conversion circuit but also to a photoelectric conversion device having another AD conversion circuit such as a delta-sigma-type AD conversion circuit or a successive approximation-type AD conversion circuit. In addition, in the first to third embodiments, an example in which the technology of the present disclosure is applied to a photoelectric conversion device having a dual slope AD conversion circuit has been described, but the technology of the present disclosure may also be applied to a photoelectric conversion circuit having a multi-slope AD conversion circuit using three or more types of reference signals.

Although the photoelectric conversion device 100 has the function of the DSP 70 in the above-described embodiments, the photoelectric conversion device 100 does not necessarily have to have the function of the DSP 70. That is, at least a part of the functions of the DSP 70 may be provided in a device different from the photoelectric conversion device 100. The other device may be, for example, a signal processing device such as a personal computer including a processor (for example, a CPU or an MPU) different from the photoelectric conversion device 100. Alternatively, the other device may be a circuit such as an ASIC that realizes at least a part of the functions of the DSP 70.

Further, the imaging systems described in the fifth and sixth embodiments exemplify photoelectric conversion systems to which the photoelectric conversion device of the present disclosure may be applied, and the photoelectric conversion system to which the photoelectric conversion device of the present disclosure may be applied is not limited to the configuration illustrated in FIG. 10 and FIG. 11A.

According to the present disclosure, even when pixel signals are processed using a plurality of different gain settings, appropriate blackening correction may be performed to obtain a good quality image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-220225, filed Dec. 16, 2024, which is hereby incorporated by reference herein in its entirety.

What is claimed is:

1. A photoelectric conversion device comprising:
a pixel including a photoelectric conversion unit configured to generate charge by photoelectric conversion, the pixel being configured to output an analog reference signal and an analog image signal;
a readout unit configured to perform gain processing and analog-to-digital conversion processing on the analog reference signal and the analog image signal to output a digital reference signal obtained by the gain processing and the analog-to-digital conversion processing on the analog reference signal and a digital image signal obtained by the analog-to-digital conversion processing and the gain processing with a first gain or a second gain smaller than the first gain on the analog image signal; and
a difference processing unit configured to output a first value generated by difference processing between the digital image signal and the digital reference signal in a case where the analog image signal is subjected to the gain processing with the first gain or a digital signal value of the digital reference signal is less than a first determination value and output a second value different from a value generated by the difference processing in a case where the analog image signal is subjected to the gain processing with the second gain and the digital signal value is equal to or greater than the first determination value.

2. The photoelectric conversion device according to claim 1, wherein the difference processing unit is configured to output the second value in a case where the analog image signal is subjected to the gain processing with the second gain, the digital signal value of the digital reference signal is equal to or greater than the first determination value, and a digital signal value of the digital image signal is equal to or greater than a second determination value and output a value generated by the difference processing in other cases.

3. The photoelectric conversion device according to claim 2, wherein the second determination value is determined based on the digital signal value of the digital image signal obtained when the analog image signal output from the pixel when the photoelectric conversion unit is saturated is processed by the gain processing with the second gain.

4. The photoelectric conversion device according to claim 1, wherein the readout unit is configured to perform the gain processing on the analog image signal with the first gain in a case where an amplitude of the analog image signal is equal to or less than an amplitude corresponding to a predetermined determination voltage and perform the gain processing on the analog image signal with the second gain in a case where the amplitude of the analog image signal is greater than the amplitude corresponding to the determination voltage.

5. The photoelectric conversion device according to claim 4, wherein the readout unit includes a slope-type analog-to-digital conversion circuit and is configured to perform the analog-to-digital conversion processing on the analog image signal using a first reference signal having a slope corresponding to the first gain in a case where the amplitude of the analog image signal is equal to or less than the amplitude corresponding to the determination voltage and perform the analog-to-digital conversion processing on the analog image signal using a second reference signal having a slope corresponding to the second gain in a case where the amplitude of the analog image signal is greater than the amplitude corresponding to the determination voltage.

6. The photoelectric conversion device according to claim 4, wherein the readout unit includes an amplifier circuit and an analog-to-digital conversion circuit and is configured to convert the analog image signal to the digital image signal by the analog-to-digital conversion circuit after amplifying the analog image signal with the first gain by the amplifier circuit in a case where the amplitude of the analog image signal is equal to or less than the amplitude corresponding to the determination voltage and convert the analog image signal to the digital image signal by the analog-to-digital conversion circuit after amplifying the analog image signal with the second gain by the amplifier circuit in a case where the amplitude of the analog image signal is greater than the amplitude corresponding to the determination voltage.

7. The photoelectric conversion device according to claim 4, wherein the readout unit is configured to perform the gain processing with the first gain and the gain processing with the second gain on the analog refence signal, output the digital reference signal based on the analog reference signal subjected to the gain processing with the first gain in a case where the amplitude of the analog image signal is equal to or less than the amplitude corresponding to the determination voltage and output the digital reference signal based on the analog reference signal subjected to the gain processing with the second gain in a case where the amplitude of the analog image signal is greater than the amplitude corresponding to the determination voltage.

8. The photoelectric conversion device according to claim 4, wherein the readout unit is configured to perform the gain processing on the analog reference signal with the first gain and output the digital reference signal based on the analog reference signal subjected to the gain processing with the first gain.

9. The photoelectric conversion device according to claim 8, wherein the difference processing unit is configured to perform the difference processing on the digital signal value of the digital reference signal multiplied by a ratio of the second gain to the first gain in a case where the analog image signal is subjected to the gain processing with the second gain.

10. The photoelectric conversion device according to claim 1, wherein the second value is a maximum value that a digital signal value of the digital image signal can take.

11. The photoelectric conversion device according to claim 1, wherein the first determination value is determined based on the digital signal value of the digital reference signal obtained when the analog reference signal output from the pixel when the photoelectric conversion unit is saturated is subjected to the gain processing with the second gain.

12. The photoelectric conversion device according to claim 1, wherein the difference processing unit is configured to output a value of the difference value multiplied by a ratio of the second gain to the first gain in a case where the analog image signal is subjected to the gain processing with the second gain as a value generated by the difference processing.

13. The photoelectric conversion device according to claim 1,
wherein the pixel comprises a plurality of pixels arranged to form a plurality of rows and a plurality of columns, and
wherein the readout unit includes a plurality of column circuit units corresponding to the plurality of columns and is configured to process signals output from the pixels of each of the plurality of columns by the plurality of column circuit units in parallel.

14. The photoelectric conversion device according to claim 13, wherein the difference processing unit is configured to sequentially process the signals output from the plurality of column circuit units.

15. A photoelectric conversion system comprising:
the photoelectric conversion device according to claim 1; and
a signal processing device configured to process a signal output from the photoelectric conversion device.

16. A movable object comprising:
the photoelectric conversion device according to claim 1;
a distance information acquisition unit configured to acquire distance information to an object from a parallax image based on a signal from the photoelectric conversion device; and
a control unit configured to control the movable object based on the distance information.

17. An equipment comprising:
the photoelectric conversion device according to claim 1; and
at least one of
an optical device corresponding to the photoelectric conversion device,
a control device configured to control the photoelectric conversion device,
a processing device configured to process a signal output from the photoelectric conversion device,
a mechanical device that is controlled based on information obtained by the photoelectric conversion device,
a display device configured to display information obtained by the photoelectric conversion device, and
a storage device configured to store information obtained by the photoelectric conversion device.

18. A signal processing device configured to perform processing using a digital reference signal obtained by gain processing and analog-to-digital processing on an analog reference signal and a digital image signal obtained by analog-to-digital conversion processing and gain processing with a first gain or a second gain smaller than the first gain on the analog image signal, the device comprising:
a difference processing unit configured to output a first value generated by difference processing between the digital image signal and the digital reference signal in a case where the analog image signal is subjected to the gain processing with the first gain or a digital signal value of the digital reference signal is less than a first determination value and output a second value different from a value generated by the difference processing in a case where the analog image signal is subjected to the gain processing with the second gain and the digital signal value is equal to or greater than the first determination value.

19. A signal processing method using a digital reference signal obtained by gain processing and analog-to-digital processing on an analog reference signal and a digital image signal obtained by analog-to-digital conversion processing and gain processing with a first gain or a second gain smaller than the first gain on the analog image signal, the method comprising:
determining whether the analog image signal is subjected to the gain processing with the second gain and a digital signal value of the digital reference signal is equal to or greater than a first determination value,
outputting a first value generated by the difference processing between the digital image signal and the digital reference signal in a case where the gain processing is performed on the analog image signal with the first gain or the digital signal value is less than the first determination value, and
outputting a second value different from a value generated by the differential processing in a case where the gain processing is performed on the analog image signal with the second gain and the digital signal value is equal to or greater than the first determination value.
